(19) United States
(12) Patent Application Publication
(10) Pub. No.: US 2024/0168358 A1
(43) Pub. Date: May 23, 2024

(54) High Quality Factor Metasurfaces for Wavefront Manipulation

(71) Applicant: California Institute of Technology, Pasadena, CA (US)

(72) Inventors: Claudio U. Hail, Pasadena, CA (US); Morgan D. Foley, Pasadena, CA (US); Ruzan Sokhoyan, Pasadena, CA (US); Lior Michaeli, Pasadena, CA (US); Harry A. Atwater, South Pasadena, CA (US)

(73) Assignee: California Institute of Technology, Pasadena, CA (US)

(21) Appl. No.: 18/516,490

(22) Filed: Nov. 21, 2023

Related U.S. Application Data
(60) Provisional application No. 63/427,038, filed on Nov. 21, 2022.

(51) Int. Cl. G02F 1/19

(52) U.S. Cl. CPC G02F 1/19; G02F 2202/30

(57) ABSTRACT

Systems and methods for optical nanostructures that use the interference of high order Mie resonances to locally control wavefront with high quality factor in two dimensions are described. The high-order Mie-resonant metasurfaces can be used to create band-stop filters, beam deflectors, lenses, beam splitters and holograms with high quality factor.

### CROSS-REFERENCE TO RELATED APPLICATIONS

The current application claims the benefit of and priority under 35 U.S.C. § 119 (e) to U.S. Provisional Patent Application No. 63/427,038 entitled “High Quality Factor Metasurfaces For Two-Dimensional Wavefront Manipulation” filed Nov. 21, 2022. The disclosure of U.S. Provisional Patent Application No. 63/427,038 is hereby incorporated by reference in its entirety for all purposes.

### GOVERNMENT SPONSORED RESEARCH

This invention was made with government support under Grant No. FA9550-21-1-0312 awarded by the Air Force. The government has certain rights in the invention.

### FIELD OF THE INVENTION

The present invention generally relates to systems and methods for high quality factor metasurfaces for two-dimensional wavefront manipulation; more sepecifically relates to high quality factor metasurfaces for two-dimensional wavefront manipulation where the metasurfaces act as optical elements and/or optical sensors.

### BACKGROUND OF THE INVENTION

The regulation of electromagnetic waves with traditional optical components, such as lenses and prisms, is realized through the accumulation of phase delay in the process of light propagation, which limits the reduction and integration of optical devices. Control of phase and amplitude plays an important part in wavefront modulation. Traditional optical elements, as well as diffractive elements such as gratings and holograms, can be bulky for optical set-up. Metasurface can modify the amplitude and impart an abrupt phase shift to the incident wave within the sub-wavelength scale through the light-matter interaction, and thus realize the wavefront modulation more efficiently.

In optical metasurfaces, a subwavelength-spaced array of localized resonators can be used to abruptly manipulate the phase, amplitude, polarization, and spectrum of light at an interface. Attaining strong light matter interaction and hence high quality factors in metasurfaces can be desirable. However, the required subwavelength scale wavefront control, imposes a limit on the resonator size, leading to significant radiative loss. As a result, most metasurfaces are broadband and rely on dielectric structures with limited light confinement and hence quality factor (less than about 15). Low quality factor means photon residence times are very short, and hence local electromagnetic fields tend to be small. It is challenging to achieve simultaneous local control over a wavefront with resonance phase and high quality factor.

### BRIEF SUMMARY OF THE INVENTION

Many embodiments are directed to systems of high quality factor metasurfaces for two-dimensional wavefront manipulation and methods thereof. In many embodiments, the electromagnetic metasurfaces enable flat optical elements that show a high quality factor, that is a highly resonant behavior with a narrow band response. The metasurfaces, also referred as nanostructures, show strong interaction with light with a large electric field enhancement inside and around the nanostructures and the capability for wavefront manipulation in two dimensions. The nanostructures in accordance with several embodiments can be used to create band-stop filters, beam deflectors, lenses, beam splitters, and/or holograms with high quality factor. In some embodiments, the nanostructures can be used to boost nonlinear optical parametric conversion of light, in harmonic generation or spontaneous parametric down conversion. In a number of embodiments, the nanostructures can operate as a highly sensitive optical sensor for changes in the dielectric environment, such as (but not limited to) refractive index, temperature, and/or concentration of an analyte. In some embodiments, the nanostructures can be adapted for immersion into a liquid environment, where they can be used for sensing the properties of the liquid environment. In certain embodiments, the nanostructures can be adapted for sensing properties in gaseous environments. The nanostructure optical sensors can measure the change in the reflectance and/or transmission spectrum, and/or the change in reflected and/or transmitted light intensity as read-out. Multiple nanostructures configured to sense different analytes or parameters may also be realized on the same substrate in accordance with various embodiments.

The metasurfaces in accordance with many embodiments can be used as compact flat optical elements with a very narrow band response in optical imaging devices, cameras, cell-phones, and/or augmented reality devices. In several embodiments, the metasurfaces can be used for nonlinear generation of light with harmonic generation, and quantum light generation by spontaneous parametric down conversion to generate entangled photon pairs as needed for quantum communication and quantum information processing. In some embodiments, the metasurfaces can be applied as optical sensors for sensing the refractive index of liquids, the temperature of the surrounding, the concentration of biomolecules in liquids, biomedical diagnostics by sensing biomarkers for such as (but not limited to) cancer diagnostics, or sensing environmental toxins. By including a dynamically tunable element into the nanostructures, the nanostructures may also be used for dynamic modulation of the wavefront for applications in light detection and ranging (Lidar) and spatial light modulators. Other applications of the nanostructures include (but are not limited to) hyperspectral imaging and on-chip spectrometry.

Some embodiments include an apparatus comprising: an electromagnetic metasurface comprising a plurality of repeating unit cells with a periodicity conformally disposed on a substrate; wherein the periodicity is less than a wavelength in free space of an operating light; wherein each of the plurality of repeating unit cells comprises at least one nanostructure with a length, a width, and a height; wherein each of the length and the width is less than the periodicity; and wherein at least two different Mie-modes, with one Mie-mode being a higher order, interfere within each of the plurality of repeating unit cells, the interference enables the apparatus to achieve a resonance in transmission or reflection such that the apparatus controls a phase of the operating light in transmission or reflection using a localized mode with a quality factor of at least 200.

In some embodiments, the at least two Mie-modes are selected from the group consisting of: an electric dipole, a magnetic dipole, an electric quadrupole, a magnetic quadrupole, an electric octupole, a magnetic octupole, an electric hexadecapole, a magnetic hexadecapole, electric 32 pole, and a magnetic 32 pole.

In some embodiments, the apparatus controls the phase of the transmitted light or reflected light in two dimensions.

In some embodiments, the wavelength is selected from the group consisting of: an ultraviolet wavelength from 100 nm to 400 nm, a visible wavelength from 380 nm to 800 nm, a near infrared wavelength from 800 nm to 2500 nm, and an infrared wavelength from 780 nm to 1000 μm.

In some embodiments, the plurality of repeating unit cells is arranged in an array.

In some embodiments, the at least one nanostructure has a shape selected from the group consisting of: a cuboid, a cube, a pillar, a cylinder, an elliptical cylinder, a trapezoid, a triangular prism, a polygonal prism, a pyramid, and a combination thereof.

In some embodiments, the at least one nanostructure has a non-symmetric shape.

In some embodiments, the at least one nanostructure comprises a lossless dielectric material with an imaginary refractive index less than or equal to 0.5 at the wavelength of operation.

In some embodiments, the substrate comprises a material with a real part of the refractive index less than the real part of the refractive index at the wavelength of operation of the at least one nanostructure.

In some embodiments, the at least one nanostructure comprises a material selected from the group consisting of: gallium arsenide, gallium phosphide, silicon carbide, titanium oxide, silicon nitride, barium titanate, lithium niobate, tantalum pentoxide, silicon oxide, amorphous silicon, silicon, and a combination thereof.

In some embodiments, the substrate comprises a material selected from the group consisting of: glass, silicon oxide, silicon nitride, gold, silver, aluminum, copper, titanium, platinum, indium tin oxide, aluminum tin oxide, aluminum zinc oxide, magnesium fluoride, tantalum pentoxide, zirconium oxide, vanadium oxide, a germanium-antimony-tellurium alloy, titanium nitride, hafnium oxide, hafnium nitride, molybdenum diselenide, hexagonal boron nitride, black phosphorous, tungsten diselenide, tungsten disulfide, and a combination thereof.

In some embodiments, the quality factor is observed in an area with a diameter of less than or equal to 100 μm due to the localized mode.

In some embodiments, the wavelength is a near infrared wavelength from 800 nm to 2500 nm, the at least two different Mie-modes are an electric dipole mode and an electric octupole mode, and the quality factor is from 202 to 1475.

In some embodiments, the electromagnetic metasurface is configured to be a part of a band-stop filter, a beam deflector, a lens, a beam splitter, or a hologram.

In some embodiments, the lens has a numerical aperture of greater than or equal to 0.8.

In some embodiments, the apparatus is polarization independent.

In some embodiments, the electromagnetic metasurface is configured to be a part of a sensor in a liquid environment or in a gaseous environment.

In some embodiments, a refractive index of each of the plurality of repeating unit cells is dynamically varied using a mechanism selected from the group consisting of: a thermo-optic effect, an electro-optic effect, a magneto optic effect, a nonlinear Kerr effect, and by electrical or optical injection of free charges in to a material of each of the plurality of repeating unit cells.

In some embodiments, the substrate comprises one or more layers; wherein a refractive index of at least one layer of the substrate is varied using a mechanism selected from the group consisting of: a thermo-optic effect, an electro-optic effect, a magneto-optic effect, a nonlinear Kerr effect, and by electrical or optical injection of free charges in to a material of each of the plurality of repeating unit cells.

In some embodiments, the substrate is a deformable substrate, and each of the plurality of repeating unit cells is dynamically displaced from one another by stretching the deformable substrate such that the displacement changes the periodicity.

Some embodiments further comprise a plurality of the electromagnetic metasurfaces, wherein the plurality of electromagnetic metasurfaces are stacked on top of each other to manipulate a monochromatic light in a consecutive manner, or manipulate broadband illuminated light at separate wavelengths.

Some embodiments include an apparatus comprising: an electromagnetic metasurface comprising a plurality of unit cells arranged in an aperiodic manner on a substrate; wherein each of the plurality of cells comprises at least one nanostructure with a length, a width, and a height determined by a phase of a transmitted or reflected light at an operating wavelength; and wherein at least two different Mie-modes, with one Mie-mode being a higher order, interfere within each of the cell, the interference enables the apparatus to achieve a resonance in transmission or reflection such that the apparatus controls the phase of the operating light in transmission or reflection in a localized mode with a quality factor of at least 200.

In some embodiments, the electromagnetic metasurface is configured to be a part of a metalens, wherein the length and the width of the unit cell at a position (x, y) is determined by an equation:

$$φ ( x , y ) = \frac{2 π}{λ} ( \sqrt{{x}^{2} + {y}^{2} + {f}^{2}} - f ) ,$$

wherein φ is the phase and λ is the wavelength of the operating light, and f is a focal length of the metalens, and wherein an electromagnetic simulation determines a relationship between the length and the width and φ.

In some embodiments, the electromagnetic metasurfaces is configured to be part of an optical element that modulates the phase of the transmitted or reflected light according to a mathematical function:

φ=f(x, y)

that depends on a position (x, y) on the metasurface, and the length , the width, and the height at the position (x, y) are configured to reproduce the phase φ, and are determined from an electromagnetic numerical simulation of the at least one nanostructure and the substrate.

In some embodiments, the at least two Mie-modes are selected from the group consisting of: an electric dipole, a magnetic dipole, an electric quadrupole, a magnetic quadrupole, an electric octupole, a magnetic octupole, an electric hexadecapole, a magnetic hexadecapole, and electric 32 pole, and a magnetic 32 pole.

In some embodiments, the apparatus controls the phase of the operating transmitted light or reflected light in two dimensions.

In some embodiments, the wavelength is selected from the group consisting of: an ultraviolet wavelength from 100 nm to 400 nm, a visible wavelength from 380 nm to 800 nm, a near infrared wavelength from 800 nm to 2500 nm, and an infrared wavelength from 780 nm to 1000 μm.

In some embodiments, the at least one nanostructure has a shape selected from the group consisting of: a cuboid, a cube, a pillar, a cylinder, an elliptical cylinder, a trapezoid, a triangular prism, a polygonal prism, a pyramid, and a combination thereof.

In some embodiments, the at least one nanostructure has a non-symmetric shape.

In some embodiments, the at least one nanostructure comprises a lossless dielectric material with an imaginary refractive index less than or equal to 0.5.

In some embodiments, the substrate comprises a material with a real part of the refractive index less than the real part of the refractive index of the at least one nanostructure.

In some embodiments, the at least one nanostructure comprises a material selected from the group consisting of: gallium arsenide, gallium phosphide, silicon carbide, titanium oxide, silicon nitride, barium titanate, lithium niobate, tantalum pentoxide, silicon oxide, amorphous silicon, and silicon.

In some embodiments, the substrate comprises a material selected from the group consisting of: glass, silicon oxide, silicon nitride, gold, silver, aluminum, copper, titanium, platinum, indium tin oxide, aluminum tin oxide, aluminum zinc oxide, magnesium fluoride, tantalum pentoxide, zirconium oxide, vanadium oxide, a germanium-antimony-tellurium alloy, titanium nitride, hafnium oxide, hafnium nitride, molybdenum diselenide, hexagonal boron nitride, black phosphorous, tungsten diselenide, tungsten disulfide, and a combination thereof.

In some embodiments, the quality factor is observed in an area with a diameter of less than or equal to 100 μm due to the localized mode.

In some embodiments, the electromagnetic metasurface is configured to be a part of a band-stop filter, a beam deflector, a lens, a beam splitter, or a hologram.

In some embodiments, the apparatus is polarization independent.

In some embodiments, the electromagnetic metasurface is configured to be a part of a sensor in a liquid environment or in a gaseous environment.

In some embodiments, a refractive index of each of the plurality of unit cells is dynamically varied in time using a mechanism selected from the group consisting of: a thermo-optic effect, an electro-optic effect, a magneto optic effect, a nonlinear Kerr effect, and by electrical or optical injection of free charges in to a material of each of the plurality of unit cells.

In some embodiments, the substrate comprises one or more layers; wherein a refractive index of at least one layer of the substrate is varied dynamically in time using a mechanism selected from the group consisting of: a thermo-optic effect, an electro-optic effect, a magneto-optic effect, or a nonlinear Kerr effect, and by electrical or optical injection of free charges in to a material of each of the plurality of unit cells.

In some embodiments, the substrate is a deformable substrate, wherein each of the plurality of unit cells is dynamically displaced dynamically in time from one another by stretching the deformable substrate.

Some embodiments further comprise a plurality of the electromagnetic metasurfaces, wherein the plurality of electromagnetic metasurfaces are stacked on top of each other to manipulate a monochromatic light in a consecutive manner, or manipulate broadband illuminated light at separate wavelengths.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention. It should be noted that the patent or application file contains at least one drawing executed in color. Copies of this patent or patent application publication with color drawing(s) will be provided by the Office upon request and payment of the necessary fee.

FIG. 1A illustrates a high quality factor optical metasurface for wavefront manipulation in accordance with an embodiment.

FIGS. 1B through 1E illustrate nanostructures of various materials, dimensions, and shapes in accordance with an embodiment.

FIGS. 2A through 2E illustrate high quality factor optical metasurface for wavefront manipulation in two dimensions in accordance with an embodiment.

FIGS. 3A through 3C illustrate array-size dependency of the metasurface in accordance with an embodiment.

FIGS. 4A through 4C illustrate high quality factor resonances in silicon nanoblock arrays in accordance with an embodiment.

FIGS. 5A and 5B illustrate comparison of experiment to simulation of the nanoblocks in accordance with an embodiment.

FIGS. 6A through 6F illustrate high quality factor beam deflection along two dimensions in accordance with an embodiment.

FIGS. 7A and 7B illustrate high quality factor beam deflection to θ of about 25.8° and φ of about 25.8° in accordance with an embodiment.

FIGS. 8A and 8B illustrate high quality factor beam deflection to θ of about 35.7° and φ of about 35.7° in accordance with an embodiment.

FIG. 9 illustrates spectral diffraction efficiency for TM deflection at different angles in accordance with an embodiment.

FIGS. 10A through 10J illustrate the measured field intensity and diffraction efficiency of high quality factor radial metalenses for focusing along two dimensions in accordance with an embodiment.

FIGS. 11A through 11C illustrate measured transmission of metalenses in accordance with an embodiment.

FIGS. 12A through 12E illustrate the measured field intensity and spectral diffraction efficiency of metalenses with high quality factor in accordance with an embodiment.

FIGS. 13A through 13F illustrate Strehl ratio calculations of characterized metalenses in accordance with an embodiment.

FIGS. 14A and 14B illustrate numerical optimization of high-quality factor TM beam deflection to φ of about 35.8° in accordance with an embodiment.

FIG. 15 illustrates the experimental set-up in accordance with an embodiment.

FIGS. 16A and 16B illustrate profiles of electric and magnetic field amplitude in a periodic array in accordance with an embodiment.

FIGS. 17A through 17C illustrate multipole expansion of an isolated nanoblock in accordance with an embodiment.

FIGS. 18A and 18B illustrate profiles of electric and magnetic field amplitude of an isolated nanoblock in accordance with an embodiment.

FIGS. 19A and 19B illustrate multipole contributions of the periodic metasurface in accordance with an embodiment.

FIGS. 20A and 20B illustrate profiles of electric and magnetic field amplitude of an isolated nanosphere in accordance with an embodiment.

FIGS. 21A through 21C illustrate light scattering from ED/EO metasurfaces in accordance with an embodiment.

FIG. 22 illustrates dipole excitation of EO/ED mode in accordance with an embodiment.

FIGS. 23A and 23B illustrate reflection and scattering analysis in accordance with an embodiment.

FIGS. 24A through 24D illustrate non-locality of asymmetry induced q-BIC prohibits 2D resonance-based wavefront manipulation in accordance with an embodiment.

FIGS. 25A through 25D illustrates effect of geometric parameter variation in accordance with an embodiment.

FIGS. 26A through 26C illustrate the effect of nanoblock side length variation in accordance with an embodiment.

FIGS. 27A through 27E illustrate reflective higher-order Mie-resonant metasurfaces in accordance with an embodiment.

### DETAILED DESCRIPTION OF THE INVENTION

The recirculation of light in a confined optical mode is a method to amplify the interaction of light and matter. The ability to confine the light to the resonating mode is quantified by the quality factor, Q, as the energy stored per round-trip optical loss in the resonator. With optical micro- and nanostructures including Fabry-Pérot cavities, whispering gallery mode resonators, photonic crystals, guided mode structures, and bound states in the continuum (BIC), quality factors of up to 10⁸ can be achieved. The high level of field enhancement and confinement attained in these structures has led to advances in sensing, active optical devices, light sources, and amplification of photon-matter coupling. However, as the mode volume of an optical resonator decreases and the mode becomes more localized, more radiative decay channels become available and the field enhancement and quality factor may diminish. As a result, there is a tradeoff between spatial mode localization and the attainable quality factor.

In optical metasurfaces, a subwavelength-spaced array of localized resonators can be used to abruptly manipulate the phase, amplitude, polarization, and spectrum of light at an interface. These structures can enable changes in optical imaging, communication, sensing, and display technology. Optical components and phenomena have been realized using metasurfaces such as efficient flat lenses, on-chip holography, and dynamic beam steering. Attaining strong light matter interaction and hence high quality factors in metasurfaces can be desirable, as it enables the realization of ultra-fast spatial light modulators, nonlinear parametric conversion, responsive optical sensing and tailored light emission.

However, the required subwavelength scale wavefront control, imposes a limit on the resonator size, leading to significant radiative loss. As a result, most metasurfaces are broadband and rely on dielectric structures with limited light confinement and hence quality factor (Q less than about 15). Local methods for wavefront manipulation are limited to low quality factors (Q less than about 20). Wavefront manipulation with increased quality factors have been made with structures relying on extended guided mode resonance and nonlocal modes based on bound states in the continuum. Guided mode resonance methods for high quality factor wavefront manipulation are limited to deflection in one dimension, require large illumination apertures, and are highly sensitive to the incident angle. (See, e.g., US Patent Publication No. 2021/0132255 A1; the disclosure of which is incorporated by reference). Non-local methods for high quality factor wavefront manipulation are limited to lower quality factors (Q less than about 150), are unable to operate under oblique incidence illumination, and are not suitable for dynamic wavefront manipulation (See, e.g., Wu, P. C. et al. Nat. Commun. 10, 1-9 (2019); Overvig, A. C., et al., Phys. Rev. Lett. 125, 17402 (2020); Overvig, A. C., et al., Physical Review B, 102(3), p.035434 (2020); Malek, S. C., et al., Light Sci. Appl. 11, 246 (2022); the disclosures of which are herein incorporated by reference.) Achieving simultaneous local control over a wavefront with resonance phase and high quality factor remains challenging.

Many embodiments provide high quality factor metasurfaces by leveraging higher-order Mie resonances to locally manipulate the wavefront of light in two dimensions based on resonance phase. In many embodiments, a metasurface comprises a plurality of optical nanostructure unit cells. The optical metasurface uses the interference of two or more higher order Mie modes in a single nanostructure unit cell to impart a local phase shift on a wavefront with high quality factor. Some embodiments superimpose higher Mie modes with lower Mie modes in order to create optical resonance within the unit cell. Examples of Mie modes that can be used in the nanostructures include (but are not limited to) electric dipoles, magnetic dipoles, electric quadrupoles, magnetic quadrupoles, electric octupoles, magnetic octupoles, electric hexadecapoles, magnetic hexadecapoles, electric 32 poles, magnetic 32 poles, and any higher modes. Specific combination of Mie modes in accordance with certain embodiments can locally manipulate the phase of the wavefront of the light. Several embodiments interfere the electric dipole mode and an electric octupole mode in optical metasurfaces at near infrared wavelengths (from about 800 nm to about 2500 nm). The metasurfaces in accordance with many embodiments enable two dimensional wavefront manipulation with high quality factor, finite illumination apertures and oblique incidence illumination. In various embodiments, the metasurfaces can achieve quality factor of at least about 200; or at least about 300; or at least about 400; or at least about 500; or at least about 600; or at least about 700; or at least about 800; or at least about 900; or at least about 1000; or at least about 1100; or at least about 1200; or at least about 1300; or at least about 1400; or at least about 1500; or at least about 1600; or at least about 1700; or at least about 1800; or less than or equal to about 1500; or from about 200 to about 1500; or from about 200 to about 1400; or from about 200 to about 1300; or from about 200 to about 1200; or from about 200 to about 1100; or from about 200 to about 1000.

The metasurfaces in accordance with many embodiments can manipulate the wavefront of light of various wavelengths with high quality factors. The light can have wavelengths ranging from ultraviolet wavelengths from about 100 nm to about 400 nm; from visible wavelengths from about 380 nm to about 800 nm; near infrared wavelengths from about 800 nm to about 2500 nm; infrared wavelengths from about 780 nm to about 1000 μm. The light being manipulated by the metasurfaces can have a single wavelength or a range of wavelengths such as broadband illumination. In order to manipulate different wavelengths of incoming light, the metasurfaces can be made of different dimensions and/or be made of different materials. In certain embodiments, the desired dimensions and/or materials of the nanostructures on the metasurfaces can be selected for the light wavelength(s). The metasurfaces can be designed to exhibit multiple high quality optical resonances that appear at different wavelengths, and show selective wavefront manipulation capabilities at different wavelengths.

The nanostructures on the metasurface can be made of various shapes and/or dimensions. The nanostructures on the metasurface can be arranged in an array; or in parallel lines; or in straight lines; or in curved lines; or in an aperiodic manner. A repeating unit of the nanostructures can be referred as a unit cell. A unit cell can include at least one nanostructure; or at least two nanostructures; or at least three nanostructures; or at least four nanostructures; or at least five nanostructures. The repeating unit cells can have a periodicity P. The nanostructure has dimensions including a length L, a width W, and a height H. In several embodiments, the periodicity P of the metasurfaces is less than the wavelength of the light. In some embodiments, the length L, the width W, and the height H of the nanostructure are less than the periodicity P. The length L, the width W, and the height H of the nanostructure can be the same or can be different. In various embodiments, the length L, the width W, and the height H scale linearly with the operating wavelength of the light. In several embodiments, the nanostructure can have a symmetrical shape. In some embodiments, the nanostructure can have a non-symmetrical shape to induce a polarization selective response or a chiral response. The nanostructure can have various shapes such as (but not limited to) cuboids, cubes, pillars, cylinders, elliptical cylinders, trapezoids, triangular prisms, polygonal prisms, pyramids, and any combinations thereof. As can readily be appreciated, any of a variety of shapes of the nanostructures can be utilized as appropriate to the requirements of specific applications in accordance with various embodiments of the invention. In some embodiments, the nanostructure can comprise a plurality layers of the same or different materials. The geometrical dimensions of the nanostructures, such as length of the L and width W, or height H, can vary arbitrarily in a non-uniform manner over the aperture of the metasurface device according to the optical function of the metasurface.

The nanostructures of the metasurfaces can be made of various materials. Suitable materials for nanostructures include materials with a large nonlinear optical susceptibility to enhance nonlinear optical parametric conversion processes and/or lossless dielectric materials. The lossless dielectric materials can have an imaginary refractive index (also known as extinction coefficient) of less than or equal to about 0.5; or less than or equal to about 0.1; or less than or equal to about 0.05 at the wavelength of operation. Examples of materials for nanostructures include (but are not limited to) gallium arsenide, gallium phosphide, silicon carbide, titanium oxide, silicon nitride, barium titanate, lithium niobate, tantalum pentoxide, silicon oxide, amorphous silicon, and silicon parallelpipeds. As can readily be appreciated, any of a variety of materials can be utilized as appropriate to the requirements of specific applications in accordance with various embodiments of the invention. In several embodiments, the refractive index of each of the unit cells can be dynamically varied in time using a mechanism such as (but not limited to): a thermo-optic effect, an electro-optic effect, a magneto optic effect, a nonlinear Kerr effect, and/or by electrical or optical injection of free charges in to the unit cell materials.

The nanostructures can be deposited on a substrate. In many embodiments, the nanostructures are deposited conformally onto the substrate. The substrate can be made of various materials. Suitable materials for nanostructures include materials with a large nonlinear optical susceptibility to enhance nonlinear optical parametric conversion processes and/or lossless dielectric materials. At the wavelength of operation, the real part of refractive index of the substrate material should be less than the real part of the refractive index of the nanostructure material in accordance with several embodiments. In several embodiments, the substrate comprises a plurality of layers of different materials. For the plurality of layers of the substrate, the first layer that is in immediate contact with the nanostructure should have a real part of the refractive index less than the real part of the refractive index of the nanostructure material at the wavelength of operation in accordance with some embodiments. Examples of materials for the substrate include (but are not limited to) glass, silicon oxide, silicon nitride, gold, silver, aluminum, copper, titanium, platinum, indium tin oxide, aluminum tin oxide, aluminum zinc oxide, magnesium fluoride, tantalum pentoxide, zirconium oxide, vanadium oxide, germanium-antimony-tellurium alloys, titanium nitride, hafnium oxide, hafnium nitride, molybdenum diselenide, hexagonal boron nitride, black phosphorous, tungsten diselenide, tungsten disulfide and any combinations thereof. In certain embodiments, the substrate can be made with elastic materials including (but not limited to) elastic polymers, silicone, polydimethylsiloxane (PDMS), poly(methyl methacrylate) (PMMA), and any combinations thereof. As can readily be appreciated, any of a variety of substrate materials can be utilized as appropriate to the requirements of specific applications in accordance with various embodiments of the invention.

In many embodiments, the substrates can be made with deformable materials. The nanostructures can be deposited conformably on the substrate. The deformable substrate can be stretched in any of a direction such that the nanostructures can be dynamically displaced and the periodicity of the unit cells can be changed. In several embodiments, the deformable substrates can be stretched in x direction, or in y direction, or in z direction, or in any diagonal direction, or in any concentric direction, in order to achieve the desired periodicity of the unit cells.

In several embodiments, the substrates can comprise one or more layers. The refractive index of at least one layer of the substrate can be varied dynamically in time using a mechanism such as (but not limited to): a thermo-optic effect, an electro-optic effect, a magneto-optic effect, or a nonlinear Kerr effect, and/or by electrical or optical injection of free charges in to the unit cell materials.

In some embodiments, the in-plane dimension of the substrates can have various sizes ranging from microns to millimeters or larger. Examples of one dimension of the substrate include (but are not limited to) greater than or equal to about 1 μm; greater than or equal to about 5 μm; greater than or equal to about 10 μm; greater than or equal to about 50 μm; greater than or equal to about 100 μm; greater than or equal to about 150 μm; greater than or equal to about 200 μm; greater than or equal to about 300 μm; greater than or equal to about 400 μm; greater than or equal to about 500 μm; greater than or equal to about 1 mm; greater than or equal to about 2 mm; greater than or equal to about 3 mm; greater than or equal to about 4 mm; greater than or equal to about 5 mm; greater than or equal to about 10 mm. The layer thickness of the substrate (i.e. in the z direction) can have a thickness ranging from 0.1 nm to several millimeters or larger.

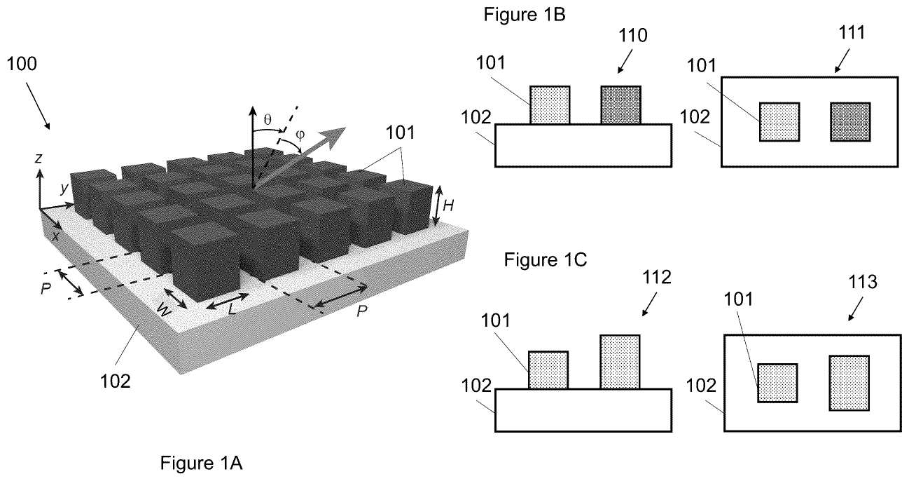

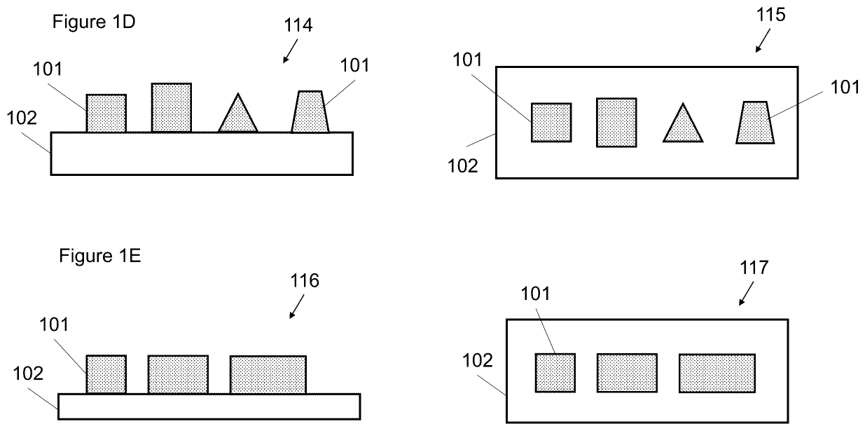

FIG. 1A illustrates a high quality factor optical metasurface for wavefront manipulation in accordance with an embodiment. The metasurface 100 comprises a plurality of nanostructures 101 on a substrate 102. The plurality of nanostructures 101 in FIG. 1A are arranged in an array. The nanostructures 101 can be arranged in different forms such as in parallel lines; or in straight lines; or in curved lines; or in an aperiodic manner. As can readily be appreciated, any of a variety of arrangement of the nanostructures can be utilized as appropriate to the requirements of specific applications in accordance with various embodiments of the invention. The nanostructures 101 have a cuboid shape with a length L, a width W, and a height H. The dimensions of the nanostructures can vary in accordance with the wavelength of the wavefront. The substrate 102 supports the plurality of nanostructures 101. In some embodiments, the substrate 102 comprises a single layer of a suitable material. In several embodiments, the substrate 102 comprises multiple layers of different materials. In certain embodiments, the substrate 102 may not be necessary and the plurality of nanostructures 101 can be supported via a membrane or a connective structure. When used in liquid environments and/or gaseous environments, the substrate may be eliminated to enhance metasurface performance. The substrate 102 can be made with a variety of materials depending on the wavelength of the incoming light and the imaginary refractive index of the nanostructure materials.

The nanostructures 101 of the metasurface can be made of different materials. Suitable materials for nanostructures include materials with a large nonlinear optical susceptibility to enhance nonlinear optical parametric conversion processes and/or lossless dielectric materials. The nanostructures 101 can comprise at least one suitable material. Multiple materials can be used for a nanostructure as appropriate to the requirements of specific applications in accordance with various embodiments of the invention. FIG. 1B illustrates the nanostructures of different materials for wavefront manipulation in accordance with an embodiment. 110 shows a cross section view of the metasurface from the x direction or the y direction. The two nanostructures 101 on the substrate 102 can be made of different materials. 111 shows a top view of the metasurface from the z direction. The nanostructures 101 on the substrate 102 can be made of different materials.

The nanostructures 101 of the metasurface can have different dimensions for light manipulation. FIG. 1C illustrates the nanostructures of different dimensions in accordance with an embodiment. 112 shows a cross section view of the metasurface from the x direction or the y direction. 113 shows a top view of the metasurface from the z direction. The nanostructures 101 on the substrate 102 can have the same length, width, and height; or different length; or different width; or different height. The length and the width of the nanostructure in accordance with some embodiments should be less than the periodicity of the metasurface and the periodicity should be less than the wavelength of the light in free space. The height of the nanostructure in accordance with several embodiments can be smaller than the periodicity of the metasurface; or greater than or equal to the periodicity of the metasurface; or greater or equal to the wavelength of the light in free space.

The nanostructures 101 of the metasurface can have different shapes for light manipulation. FIG. 1D illustrates the nanostructures of different shapes in accordance with an embodiment. 114 shows a cross section view of the metasurface from the x direction or the y direction. 115 shows a top view of the metasurface from the z direction. The nanostructures 101 can have symmetrical shapes or non-symmetrical shapes. The nanostructures can have shapes such as (but not limited to) cuboids, cubes, pillars, cylinders, elliptical cylinders, trapezoids, triangular prisms, polygonal prisms, pyramids, and any combinations of the above shapes thereof.

A repeating unit of the nanostructures can be referred as a unit cell. In FIG. 1A, a single nanostructure can be referred as a unit cell. FIG. 1E illustrates a unit cell comprising multiple nanostructures in accordance with an embodiment. 116 shows a cross section view of the metasurface from the x direction or the y direction. 117 shows a top view of the metasurface from the z direction. As shown in FIG. 1E, three nanostructures form a repeating unit on the metasurface as a unit cell.

In some embodiments, higher order Mie modes such as the electric dipole mode and an electric octupole mode can be interposed in the optical nanostructures on the metasurface at near infrared wavelengths. In certain embodiments, the electric dipole mode and an electric octupole mode in nanostructures comprising silicon parallelepipeds on a substrate comprising silicon oxide interfere at near infrared wavelengths. The nanostructures can be made of an array of silicon parallelpipeds with varying geometrical dimensions on a glass substrate. Several embodiments implement the metasurfaces as band stop filters, beam deflectors and radial lenses with quality factor in the range from about 200 to about 1500; or from about 202 to about 1475. The control over the wavefront in accordance with various embodiments is local and allows for operation with finite illumination apertures and angled illumination.

The higher-order Mie-resonant metasurface in accordance with many embodiments enable high quality factor two-dimensional wavefront manipulation. By spectrally overlapping an electric dipole and electric octupole mode, a sharp resonance in transmission can be obtained that enables local control of the wavefront of light. Using local phase control, several embodiments achieve beam deflectors with high directivity and quality factors Q from about 288 to about 1475. In some embodiments, radial lensing with near-diffraction-limited focusing and quality factors Q from about 314 to about 880 can be achieved. Due to the local nature of these modes, high quality factors can be observed with small illumination areas, for example less than or equal to about 100 μm; or less than or equal to about 50 μm; or less than or equal to about 30 μm, in diameter. Several embodiments provide consistent fabrication processes of the metasurface structures with high yield and high reproducibility. The quality factors can be limited by fabrication imperfections and coupling between neighboring structures. Higher quality factors may be realized by using structures supporting different higher-order Mie modes in accordance with embodiments. The amplitude variation across the resonant mode can be reduced by modifying the device design, for example by operating in reflection, or by using other types of higher order modes such as magnetic octupole, hexapoles or toroidal modes.

The high level of wavefront control and strong light interactions with the metasurface in accordance with various embodiments, as evidenced by the high quality factor, make the higher-order Mie-resonant metasurfaces suitable for optical sensing, nonlinear optics, directional lasing, and active wavefront manipulation. Compared to non-local metasurfaces, the metasurfaces in several embodiments are polarization independent, robust against incidence angle variations and show higher quality factor, efficiency, and numerical aperture. Furthermore, in non-local metasurfaces the quality factor for a given numerical aperture is limited by the bandstructure, and a single layer surface shows an upper bound of about 25% efficiency. The locally controlled metasurfaces in accordance with some embodiments do not show these limitations. In certain embodiments, the metasurfaces may not need additional polarization optics and are advantageous for implementation of active optical devices that dynamically modulate the dielectric environment of a metasurface unit cell. For example, by introducing a refractive index change in the nanoblocks using either the thermo-optic or electro-optic effect, the metasurface may be used to dynamically steer light. The high-Q metasurfaces may also be realized at visible wavelengths, where the narrow spectral response is advantageous for display and coloring applications.

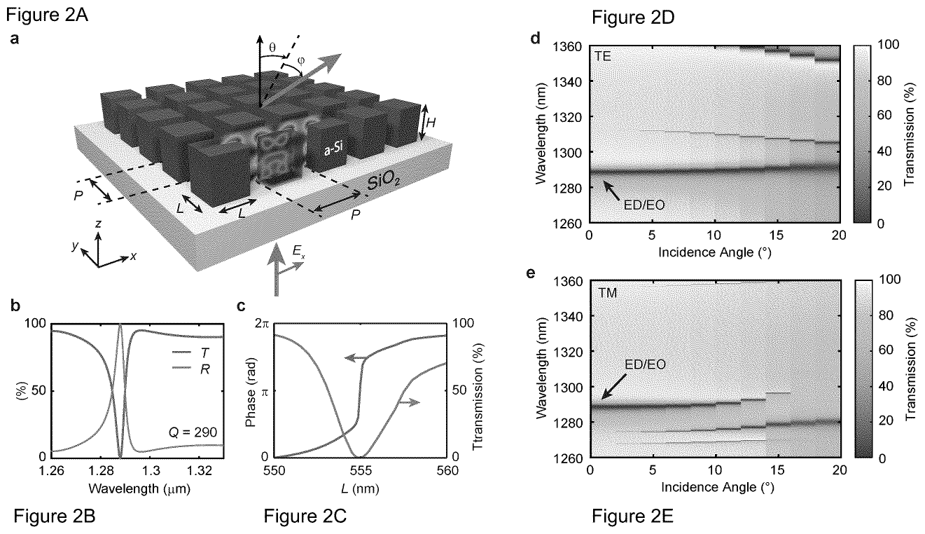

FIG. 2A illustrates high quality factor optical metasurface for wavefront manipulation in two dimensions in accordance with an embodiment. The surface comprises subwavelength-spaced amorphous silicon nanoblocks (or nanostructures) of length L and height H arranged in a square array with periodicity P on a transparent glass substrate. The structure dimensions are in the sub-diffractive regime, both in air and in the substrate, to avoid exciting any lattice modes. The geometric parameters are chosen to induce and spectrally overlap an electric dipole (ED) and electric octupole (EO) mode in the nanoblocks at near infrared wavelengths. With the ED and EO mode, the surface operates as a higher-order Mie-resonant metasurface enabling local control over the transmitted wavefront. The surface can be illuminated at normal incidence and can deflect light along the angles θ and φ in the full upper hemisphere.

FIG. 2B shows the transmission (T) and reflection (R) spectra of the metasurface with a uniform nanoblock side length L of about 555 nm, P of about 736 nm, H of about 695 nm in accordance with an embodiment. FIG. 2C illustrates calculated transmission intensity and phase with varying nanoblock side length L, P of about 736 nm, and H of about 695 nm at a wavelength of I of about 1288 nm. FIGS. 2D and 2E illustrate simulated transmission of the metasurface in FIG. 2A with varying angle of incidence for TE (FIG. 2D) and TM (FIG. 2E) polarization. The calculation can be done with finite difference time domain (FDTD) simulations. A multipole expansion of the modes inside a single nanoblock embedded in the array shows that the ED and EO modes are in phase and of similar strength on resonance. The destructive interference of the ED/EO mode and the illumination induces a sharp dip in transmission and near-unity reflection on resonance. A quality factor Q of about 290 can be obtained from a Fano resonance fit. On resonance, the electric field in the resonator shows a strong field enhancement of more than 28 times the incident field amplitude. Furthermore, the EO mode is visible in the electric and magnetic field profiles. Interference of multiple extended or local modes can be a strategy to achieve a high quality factor optical response. Analyzing the light scattered from the metasurface with varying nanoblock aspect ratios suggests that the ED/EO mode is different from extended supercavity modes or supercavity modes reported in isolated nanoparticles.

Due to the near-field coupling of the ED and EO among neighboring elements, the resonance is dependent on the array size, i.e., number of repetitions of the unit cell, which can be a signature of a partially delocalized mode. This array size dependence is similar to low-order Mie-resonant metasurfaces or asymmetry-induced quasi-BIC structures. The calculations suggest that for an array size beyond 10×10 unit cells, there may be no further significant change in the modal properties. For the ED/EO mode, the increase in quality factor can be attributed with increasing array size to an enhancement of the ED through multipole coupling of the ED and EO in the array through neighboring particles. To further provide insight into the ED/EO mode, several embodiments provide analysis of its degree of localization. Exciting the mode in a single nanoblock of the array shows that it localized within the nanoblock but extends primarily to its nearest neighbors along the direction of polarization. From this calculation, a mode volume of about 3.6 times the volume of a unit cell, or 0.86 I³ can be determined, where I is the wavelength in free space. The mode localization can also be inferred from its dependence on the incidence-angle of the illumination (see FIG. 2D and 2E). The ED/EO modes can be excited at oblique incidence for both TE and TM polarization. A spectral shift of the resonance of less than about 2 nm for a 10° change in the incident angle can be observed. For comparison, a fully delocalized lattice mode (Wood's anomaly) or guided mode resonance at the same resonance wavelength may result in a spectral shift on the order of about 130 nm for the same 10° change. The observed flat angular dispersion (angular dependent resonance wavelength shift) of the metasurface in accordance with embodiments indicates that the high-Q mode is localized. Furthermore, the dispersion is of similar order in low-order Mie-resonant metasurfaces based on the spectral overlap of an electric and magnetic dipole.

In many embodiments, the local response of the higher-order Mie-resonant metasurface enables local wavefront manipulation by controlling the phase of the transmitted light. Varying the length L of the nanoblocks can spectrally shift the ED and EO modes, and hence the resonance wavelength. The spectral shift accompanying the change in length L allows employing the resonance phase to impose a phase shift on the transmitted light. FIG. 2C shows that varying the nanoblock side length by about ±1% may allow the phase of the transmitted light to be controlled over almost the entire 0-2p range at a fixed wavelength I of about 1288 nm. The inherent symmetry of the unit cell and the resonant mode also result in a polarization-independent response. In some embodiments, a small variation (≤1%) of the length L by dL of one block in an array of nanoblocks with uniform length L, manifests itself in a local resonance shift of the single nanoblock acting as an effective point source scatterer. Furthermore, the resonant mode remains intact, and the high quality factor is preserved. The metasurfaces in accordance with some embodiments exhibit about four-fold rotational symmetry and support partially delocalized ED/EO modes. These characteristics render the metasurfaces suitable for high quality factor wavefront manipulation in two dimensions.

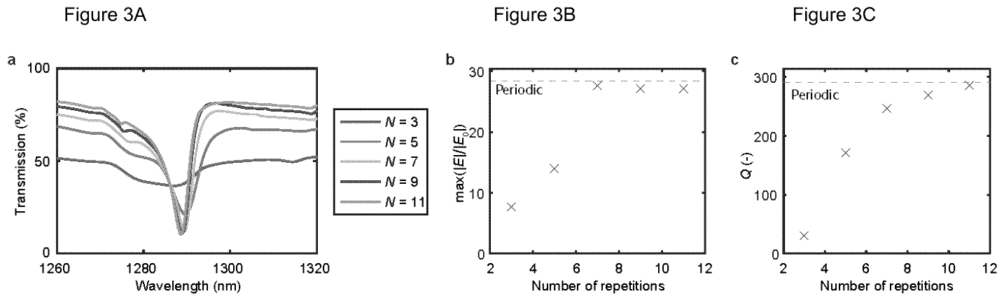

FIGS. 3A through 3C illustrate array-size dependency of the metasurface in accordance with an embodiment. FIG. 3A shows simulated transmission of a finite array of N×N nanoblocks with L about 555 nm, H about 695 nm, and P about 736 nm for varying numbers of repetitions N in the array. FIG. 3B shows maximum electric field enhancement in the central nanoblock of the finite array with varying number of repetitions. FIG. 3C shows quality factor of the transmitted light of the finite array of nanoblocks with varying number of repetitions. The dashed lines in FIGS. 3B and 3C show the field enhancement and quality factor of the periodic array for comparison. Beyond N=10 the response of the finite array is similar to the periodic case.

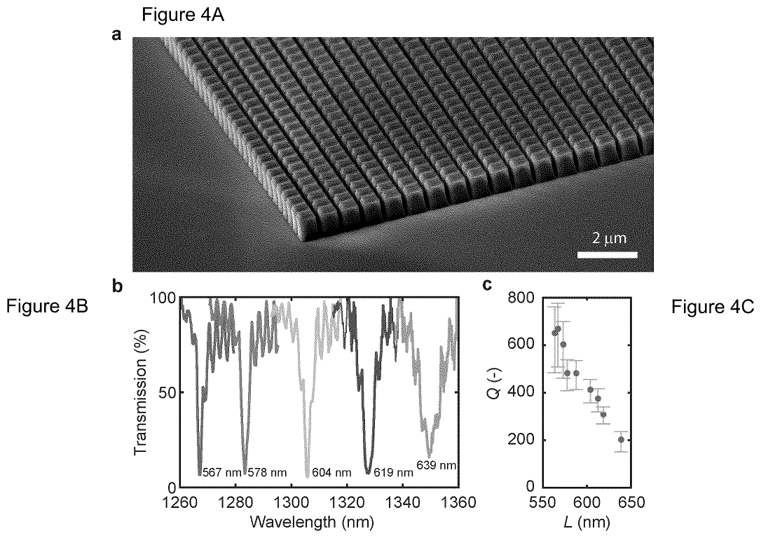

Several embodiments fabricate the high-Q metasurfaces by single-step electron beam lithography and dry etching. Some embodiments implement single-step electron beam lithography and dry etching of plasma-deposited amorphous silicon on a glass substrate (see Examples for details). FIGS. 4A through 4C illustrate high quality factor resonances in silicon nanoblock arrays in accordance with an embodiment. FIG. 4A illustrates a scanning electron micrograph of a metasurface with uniform nanoblock side lengths. FIG. 4B illustrates experimentally measured transmission spectra of high quality factor metasurfaces with varying nanoblock side length. The measured nanoblock side length in nm is indicated next to each curve, P of about 736 nm and H of about 695 nm. FIG. 4C illustrates experimentally measured quality factors with varying nanoblock side lengths as determined by a Fano lineshape fit. The error bars illustrate the 95% confidence interval of the fit. The metasurface size is about 150 μm×150 μm.

To experimentally characterize the surfaces, linearly polarized, normally incident light can be employed through the substrate from a wavelength-tunable diode laser, collected the transmitted light with an objective lens and imaged it onto an InGaAs IR-camera, or focused it onto a power meter. FIG. 4B shows the measured transmission spectra of metasurfaces with uniform nanoblock side lengths in accordance with an embodiment. A strong dip in transmission is observed on resonance with a narrow linewidth ranging between about 2 nm and about 8 nm. On resonance the measured minimum transmission ranges between about 6% and about 16%. The corresponding measured quality factors range between about 202 and about 668 as determined by fitting a Fano lineshape function. With uniform nanoblock sizes, the metasurface acts as an ultra-thin narrowband bandstop filter. An increase in nanoblock side length of a few nanometers can red shift the resonance by more than the linewidth. Furthermore, increasing the nanoblock side length beyond L of about 578 nm, leads to a decrease in the quality factor. The side length can be a convenient parameter for adjusting the quality factor by design. The high-frequency oscillation in the transmission spectrum can be due to the interference of light reflecting at the top and bottom surface of the substrate. The measurements are taken with an illumination spot diameter of 30 μm. This confirms that both the finite array size, and varying incident angles have a negligible effect on the optical response of the surface. The measured quality factors are higher than expected from simulations. However, when fabrication imperfections, such as non-vertical sidewalls and a structure undercut, are accounted for in the simulation, the calculated quality factors increase and good agreement with the measured transmission spectrum can be obtained. The measured quality factors of the uniformly-sized metasurfaces are higher or on par with measured quality factors of metasurfaces based on asymmetry-induced quasi-BIC, toroidal modes, or electromagnetically induced transparency. (See, e.g., Tittl, A. et al., Science 360, 1105-1109 (2018); Yesilkoy, F. et al., Nat. Photonics 13, 390-396 (2019); Campione, S. et al., ACS Photonics 3, 2362-2367 (2016); Jeong, J. et al., ACS Photonics 7, 1699-1707 (2020); Yang, Y., et al., Nat. Commun. 5, 1-7 (2014); the disclosures of which are herein incorporated by reference.). In addition, the metasurfaces in accordance with some embodiments allow for local manipulation of the resonance phase. The measured near-complete extinction of the transmission on resonance is evidence that the nanoblocks are fabricated with a high degree of size uniformity. A comparison with electromagnetic simulations suggests the nanoblocks are fabricated with a standard deviation in the length L of less than about 6 Å. For silicon, this represents a near single atomic layer precision in nanostructuring of the metasurface.

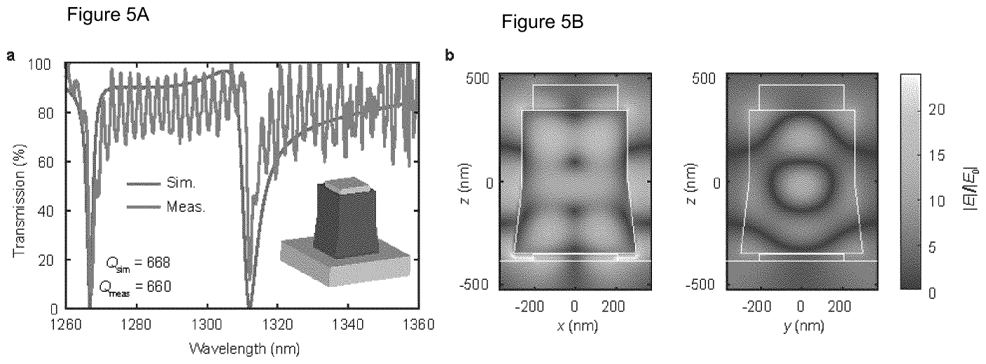

FIGS. 5A and 5B illustrate comparison of experiment to simulation of the nanoblocks in accordance with an embodiment. FIG. 5A shows measured transmission of a nanoblock array with L about 567 nm, H about 695 nm, and P about 736 nm and simulated transmission with modifications in the geometry to account for fabrication imperfections. In the simulation, the length of the nanoblock L about 516 nm, the side wall tilt a about 12.9°, the height H about 699 nm, the length and height of the remaining SiO₂ hard mask L_{SiO2} about 416 nm and H_{SiO2} about 120 nm, and the undercut du about 35 nm deep and 65 nm wide. FIG. 5B shows simulated electric field amplitude profiles in an x-z and y-z cross sections of a periodic amorphous silicon nanoblock array on a glass substrate at λ about 1267 nm, with modification in the geometry to account for fabrication imperfections. The modeled fabrication imperfections include tilted side walls, an undercut below the nanoblock and a residual SiO₂ hard mask as indicated by the white solid lines in FIG. 5B. The simulated and measured quality factors Qₛᵢₘ of about 660 and Qₘₑₐₛ of about 668 are in good agreement.

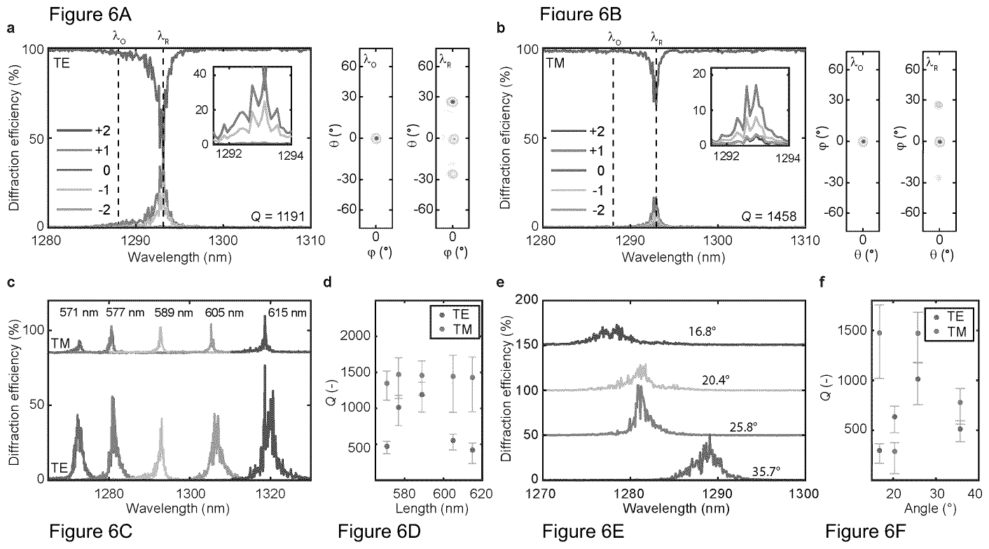

To selectively deflect light over a narrow wavelength range, several embodiments imprint a linear phase gradient on the transmitted light by varying the nanoblock side lengths along one of the metasurface in-plane directions. The nanoblock size lengths are set based on the phase look up table determined from numerical simulations in FIG. 2C, by applying a traditional forward design. Fourier plane imaging of the transmitted light can be performed to characterize the light deflection of the metasurface. FIGS. 6A through 6F illustrate high quality factor beam deflection along two dimensions in accordance with an embodiment. FIG. 6A and 6B show experimentally measured diffraction efficiencies of the −2, −1, 0, +1 and +2 diffraction orders and Fourier plane images of a metasurface showing (a) TE deflection of x-polarized light along the y direction and (b) TM deflection of x-polarized light along the x direction. The desired diffraction order is +1, with θ of about 26° and φ of about 26° , respectively. The insets show a zoomed in region of the plots. FIG. 6C shows measured diffraction efficiency of TE and TM light deflection in the +1 diffraction order with varying average nanoblock side lengths. The values for TM deflection are shifted vertically by 85% for better illustration. FIG. 6D shows measured quality factors of light deflection with varying average nanoblock side length. FIG. 6E shows measured diffraction efficiency of TE light deflection with varying deflection angle. The curves are shifted vertically by 50% from each other for better visibility. FIG. 6F shows measured quality factors of light deflection with varying deflection angles. The error bars in (d) and (f) illustrate the 95% confidence interval of the fit. For all metasurfaces P is about 736 nm and H is about 695 nm. The metasurface size is 150 μm×150 μm.

FIG. 6A shows the measured spectral diffraction efficiency and images of the Fourier plane of the light transmitted through a high-Q beam deflector metasurface in the on- and off-resonance case for deflecting x-polarized light along the y direction. This results in a transverse electric (TE) polarization of the deflected light, referred to as TE deflection. On resonance, light is preferentially deflected to an angle θ of about 26° (φ of about 0°) from the surface normal as determined by the linear phase gradient of the metasurface along the y direction corresponding to 2π/4P. At the design wavelength AR of about 1293 nm, a diffraction efficiency of about 41.2% is attained. The remaining power is coupled to the normal and opposite direction at θ of about −26°. Notably, in a representative off-resonant case, at λ_{O}=1288 nm, about 97.4% of the transmitted light remains in the surface normal direction. The measured quality factor of the TE light deflection Q is about 1191. By imprinting a phase gradient along the orthogonal direction (i.e. along the x direction) of the metasurface, light of the same polarization is deflected along the x-direction to an angle φ of about 26° (θ about 0°) with a maximum diffraction efficiency of about 17.1% at λ_{R} of about 1293 nm (FIG. 6B), due to the polarization-independent response. The result is a transverse magnetic (TM) polarization of the deflected light, referred to as TM deflection. Here, a larger quality factor Q of about 1458 is measured. Off-resonance, at λ_{O} of about 1289 nm, about 98.1% of the transmitted light remains in the normal direction.

The operating wavelength for beam deflection can be adjusted by shifting the average length of nanoblocks. FIGS. 6C and 6D illustrate the measured spectral diffraction efficiency and quality factors for TE and TM deflection for surfaces with varying operating wavelength and fixed phase gradient. By modifying the phase gradient imprinted on the surface, light can be deflected to different angles. FIGS. 6E and 6F illustrate the measured spectral diffraction efficiency for TE light deflection and quality factors for TE and TM deflection for surfaces deflecting light to different angles. Overall, the obtained diffraction efficiencies on resonance for the desired deflection angle range between about 22-76.6% and about 4-19.1% for the TE and TM deflection, respectively. The lower diffraction efficiency obtained for TM polarized deflection compared to TE is likely due to nearest-neighbor coupling between the nanoblocks. For TM deflection, the nearest-neighbor coupling occurs along the direction of the phase gradient, therefore making this case more prone to local phase errors that arise from coupling between nanoblocks and fabrication imperfections. The attained Q factors for TE and TM deflection range between Q_{TE} from about 298 to about 1191 and Q_{TM} from about 288 to about 1475. These results illustrate that light can be deflected along two dimensions to arbitrary angles θ and φ with high quality factor. This contrasts with previous demonstrations of high quality factor metasurfaces based on guided mode resonance structures, which are inherently one-dimensional in their light deflection capability, and require large illumination apertures and precise configuration of the incidence angle.

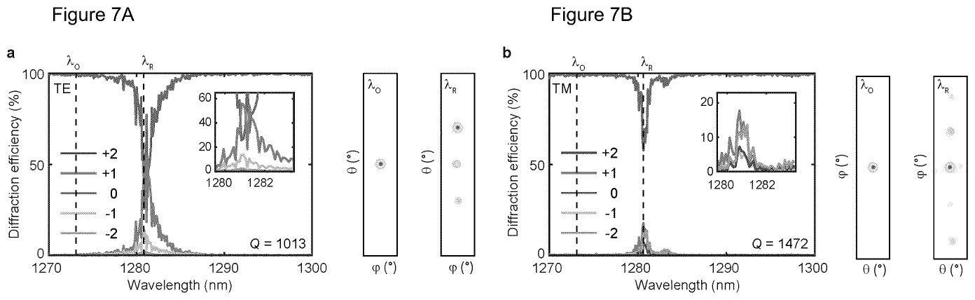

FIGS. 7A and 7B illustrate high quality factor beam deflection to e of about 25.8° and φ of about 25.8° in accordance with an embodiment. FIGS. 7A and 7B show experimentally measured diffraction efficiencies of the −2, −1, 0, +1 and +2 diffraction orders and Fourier plane images of a metasurface showing (a) TE deflection of x-polarized light along the y direction and (b) TM deflection of x-polarized light along the x direction. The desired diffraction order is +1, with θ of about 25.8° and φ of about 25.8° respectively. On resonance, λ_{R} is about 1280.8 nm, a diffraction efficiency of 55.9% and 17.7% is attained for the TE and TM mode, respectively. Off-resonance, λ_{O} of about 1273 nm, 99.6% and 99.6% of the transmitted light remains in the surface normal direction. The insets show a zoomed in region of the plots.

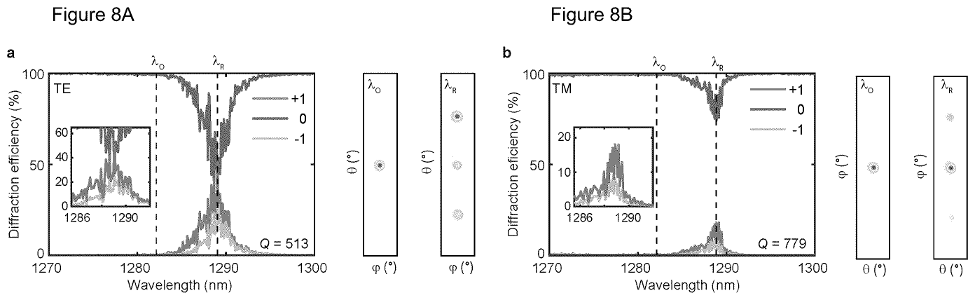

FIGS. 8A and 8B illustrate high quality factor beam deflection to e of about 35.7° and φ of about 35.7° in accordance with an embodiment. FIGS. 8A and 8B show experimentally measured diffraction efficiencies of the −1, 0 and +1 diffraction orders and Fourier plane images of a metasurface showing (a) TE deflection of x-polarized light along the y direction and (b) TM deflection of x-polarized light along the x direction. The desired diffraction order is +1, with θ of about 35.7° and φ of about 35.7° respectively. On resonance, AR of about 1289 nm, a diffraction efficiency of 51% and 18.1% is attained for the TE and TM mode, respectively. Off-resonance, λ_{O} of about 1282 nm, 99.4% and 50.98% of the transmitted light remains in the surface normal direction. The insets show a zoomed in region of the plots.

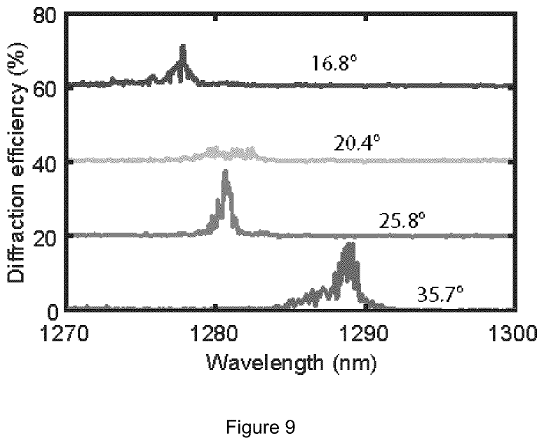

FIG. 9 illustrates spectral diffraction efficiency for TM deflection at different angles in accordance with an embodiment. Measured spectral diffraction efficiency of TM light deflection with varying deflection angle from the same structures as shown in FIG. 6E for TE light deflection. The measured curves are shifted by about 20% from each other for better visibility.

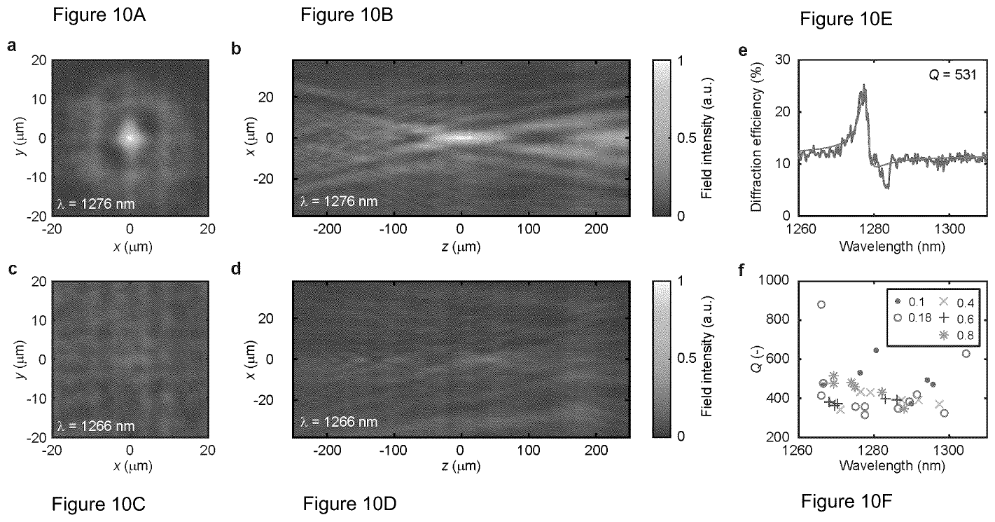

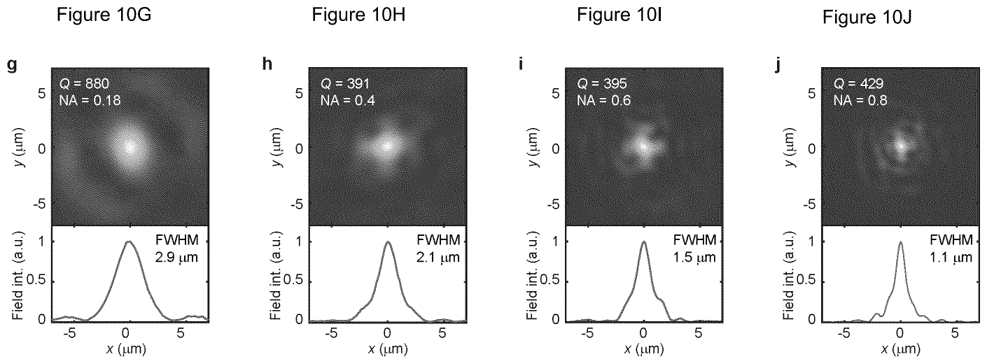

To demonstrate the wavefront shaping capabilities of the metasurfaces, several embodiments realize high quality factor radial metalenses that focus light along two dimensions over a narrow wavelength range. The metalenses are designed by imposing a paraboloidal phase profile on the transmitted light by setting the nanoblock size lengths according to the look up table in FIG. 2C. FIGS. 10A through 10J illustrate high quality factor radial metalenses for focusing along two dimensions in accordance with an embodiment. FIG. 10A shows measured field intensity at the focal plane (x-y plane) on resonance at λ of about 1276 nm of a high-Q metalens with 0.1 NA. FIG. 10B shows measured field intensity along the optical axis in the x-z plane on resonance. FIG. 10C shows measured field intensity at the focal plane off resonance at a representative wavelength λ of about 1266 nm. FIG. 10D shows measured field intensity along the optical axis in the x-z plane off resonance. The scaling of the color maps in (a), (b), (c) and (d) is identical. FIG. 10E shows measured spectral diffraction efficiency of the metalens with 0.1 NA and Q of about 531. The red line shows a Fano fit to the measurement. FIG. 10F shows measured quality factors of fabricated lenses with different resonance wavelengths and numerical apertures of about 0.1, 0.18, 0.4, 0.6 and 0.8. FIGS. 10G through 10J show measured field intensity at the focal plane (x-y plane) on resonance of four high-Q metalenses with numerical apertures of 0.18, 0.4, 0.6 and 0.8, respectively. The resonance wavelengths are about 1266 nm, 1291.8 nm, 1285.5 nm, and 1281.4 nm, respectively. The insets denote the full width at half maximum (FWHM) of the focusing. The metalenses are 100 μm in diameter and P about 736 nm and H about 695 nm.

FIGS. 10A and 10B illustrate the measured electric field intensity in the focal plane and in a cross section along the optical axis of a metalens with a numerical aperture of about 0.1 at the resonance wavelength of λ about 1276 nm. On resonance, light is symmetrically focused to a near-diffraction-limited focal spot. However, at λ of about 1266 nm, at a wavelength only 10 nm away from the resonance wavelength, light propagates through the metalens without focusing (see FIGS. 10C and 10D). FIG. 10E shows the measured spectral diffraction efficiency of the metalens, highlighting its wavelength-selective operation. The maximum diffraction efficiency is about 25.3% on resonance. From the spectral diffraction efficiency, a quality factor Q of about 531 is determined for the metalens. The measured transmittance of the lens on resonance is about 55.6%. FIG. 10F illustrates measured quality factors from different lenses with numerical apertures ranging from 0.1 to 0.8 and varying operating wavelength. A similar trend in increased quality factors towards shorter wavelength, as in FIG. 4B, is observed. A quality factor Q of about 880 is obtained for a lens with 0.18 NA. FIGS. 10G through 10J illustrate the measured electric field intensity in the focal plane for metalenses with numerical apertures of 0.18, 0.4, 0.6 and 0.8. The observed full width at half maximum of the focus is in good agreement with the diffraction limited values. The Strehl ratios of the characterized lenses range within 0.1-0.57. Both the measured Strehl ratios and diffraction efficiencies decrease with increasing numerical aperture, which can be attributed to an increased wavefront distortion due to coupling between neighboring elements, which increases with larger phase gradients.

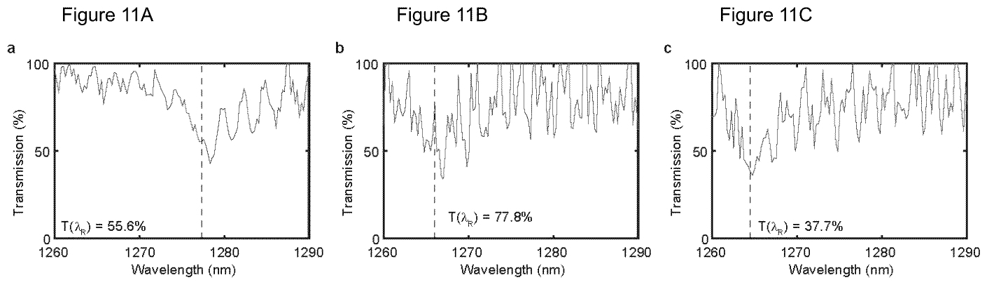

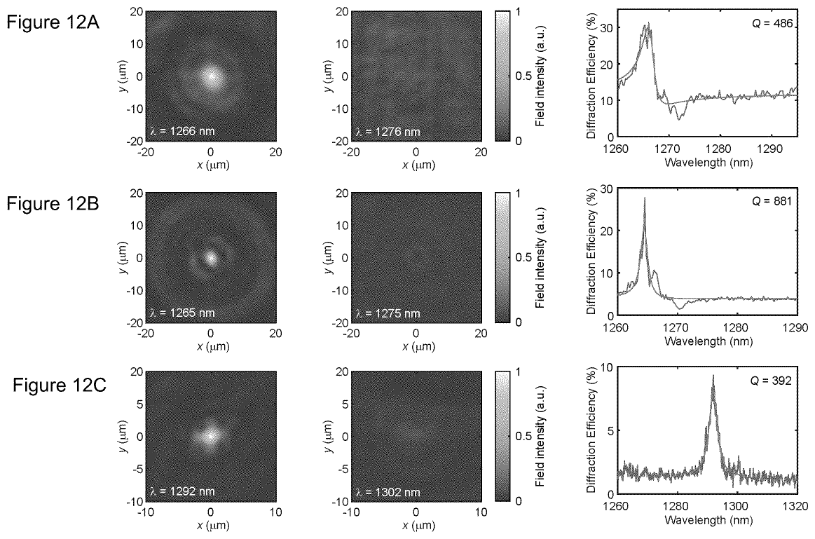

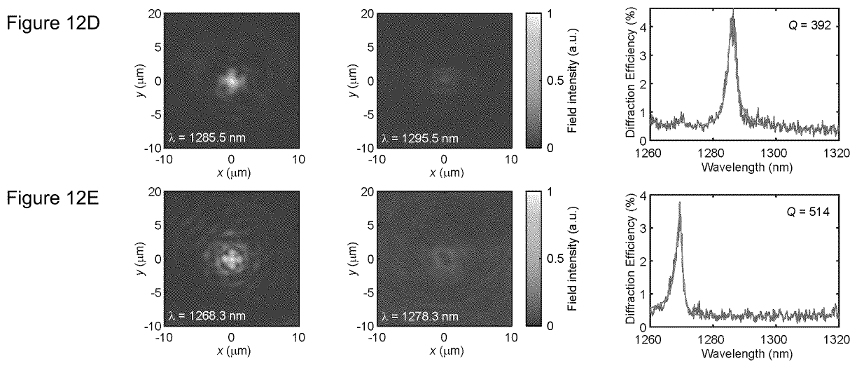

FIGS. 11A through 11C illustrate measured transmission of metalenses in accordance with an embodiment. FIG. 11A shows measured transmittance of the metalens from FIGS. 10A through 10E. The transmission on resonance is about 55.6%. FIG. 11B shows measured transmittance of the metalens from FIG. 12A. The transmission on resonance is about 77.8%. FIG. 11C shows measured transmittance of the metalens from FIG. 12B. The transmission on resonance is about 37.7%. The resonance wavelength is the wavelength where the focusing efficiency is maximized.

FIGS. 12A through 12E illustrate metalenses with high quality factor in accordance with an embodiment. FIGS. 12A through 12E show measured field intensity at the focal plane on resonance and off resonance, and the measured spectral diffraction efficiency of metalenses with numerical aperture of (a) 0.1 (b) 0.18 (c) 0.4 (d) 0.6 (e) 0.8. The respective resonance wavelengths and determined quality factors are indicated on the panels.

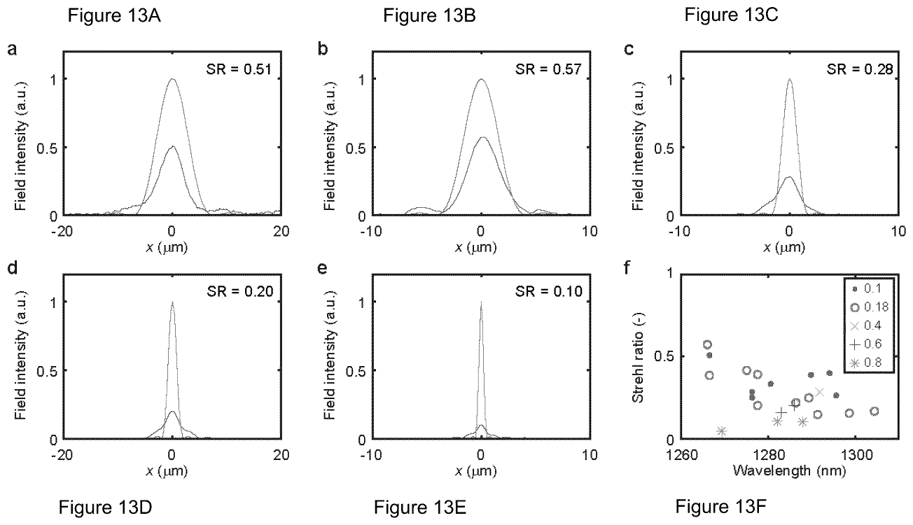

FIGS. 13A through 13F illustrate Strehl ratio calculations of characterized metalenses in accordance with an embodiment. FIGS. 13A through 13E show measured field intensity profile at the focal plane on resonance of high-Q metalenses (blue) and an airy disk function (red) with the same numerical aperture for comparison. FIG. 13F shows calculated Strehl ratios for the characterized metalenses with numerical apertures of 0.1, 0.18, 0.4, 0.6 and 0.8 and different resonance wavelengths. The Strehl ratio is calculated by integrating the intensity in the focal plane around the focal spot within a radius of eight times the diffraction-limited airy disk radius.

In wavefront shaping with high quality factors there is an inherent tradeoff between quality factor and accurate phase sampling due to fabrication limitations. This can be due to the rapid variation of the phase on resonance. For example, in the nanostructures, the phase of the transmitted light varies with 9.4 rad/nm within the range of π/2 to 3π/2 (see FIG. 2B). As a result, a precision of the nanorod side length of 0.17 nm is required to sample the phase at a π/2 increment in this range. Furthermore, this required precision generally becomes stricter when increasing the quality factor. The fabrication process results in an accuracy of the nanoblock side length of less than 0.6 nm, which produces considerable errors in phase sampling, in turn causing the appearance of stray light in the focal plane of the fabricated metalenses (FIG. 10J). This shows that fabrication imperfections are currently a limiting factor in the demonstrated quality factors and diffraction efficiencies. Higher fabrication uniformity and lower side wall surface roughness can improve performance. While there is still room for improving the electron beam lithography-based process, using methods such as scanning probe lithography or atomic layer etching may allow fabrication with near atomic layer accuracy. Another approach can be to employ different optical modes and unit-cell geometries that enable wavefront shaping with similar quality factors but with more relaxed fabrication requirements. For example, a configuration in reflection with similar quality factors shows a slower variation of the phase of 2.64 rad/nm requiring only a 0.6 nm precision to sample the phase at a π/2 increment in the π/2 to 3π/2 range. Furthermore, accounting for fabrication imperfections in the device design is also expected to result in better device performance. This could be done by creating a new iteration of the phase look up table (FIG. 2C) by considering the fabrication imperfections identified in FIGS. 5A and 5B. In addition to fabrication constraints, the local approximation used to design the phase profile along the array also limits the maximum efficiency of the devices due to non-negligible long-range coupling between unit cells. However, this is not a fundamental limitation, and an improved performance can be attained by accounting for nanoblock coupling in the design, applying design optimization approaches or by employing inverse design concepts. A particle swarm optimization can be used to optimize the design of the structure for TM light deflection resulting an increase in the diffraction efficiency from about 47% to about 82%.

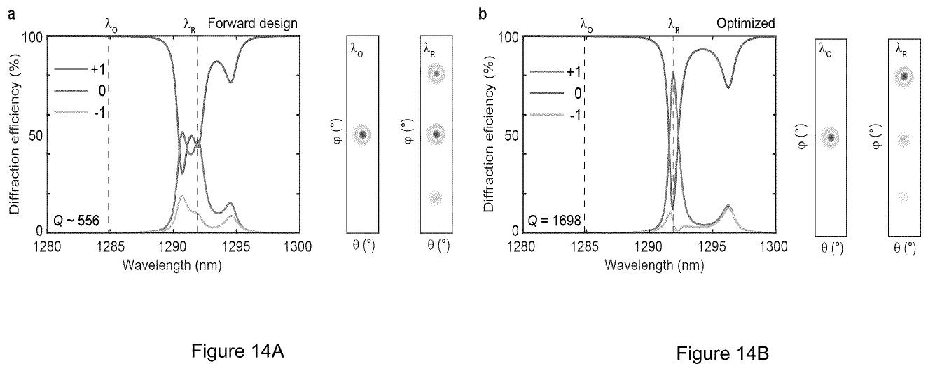

FIGS. 14A and 14B illustrate numerical optimization of high-quality factor TM beam deflection to o of about 35.8° in accordance with an embodiment. FIGS. 14A and 14B show simulated diffraction efficiencies of the −1, 0, and +1 diffraction orders and Fourier plane images of a metasurface showing TM deflection of x-polarized light along the x direction for (a) a forward design structure and (b) an optimized structure using a particle swarm optimization. The desired diffraction order is +1, with φ of about 35.8°. On resonance, λ_{R} is about 1291.9 nm, a diffraction efficiency of about 46.5% and 81.9% is attained for the forward design and the optimized design, respectively. The design includes 3 nanoblocks per Fresnel zone and nanoblock side lengths are [553.9, 554.9, 557] nm and [554.8, 554.9, 558] nm for the forward design and optimized design respectively. For the optimization the rod lengths L₁ and L₂ are varied and L₂ is fixed. Additionally, the smallest mesh refinement is set to 10 nm, to reduce the computational cost of the optimization.

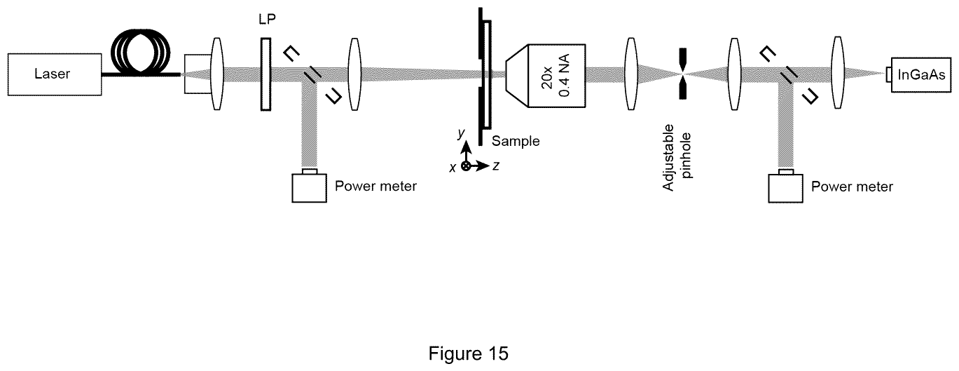

FIG. 15 illustrates the experimental set-up in accordance with an embodiment. The fabricated samples are illuminated in transmission with loosely focused light from a tunable diode laser. The transmitted light is collected by an imaging objective (20×, 0.4 NA) and projected onto an InGaAs IR camera through a set of lenses. With a flip mirror the transmitted light can be either sent to the camera or to a power meter. In the detection path an image plane is formed with an adjustable iris to limit the area that is projected on the camera or power meter. For Fourier plane imaging a 0.9 NA objective lens is used, and a Fourier plane is formed on the camera sensor by exchanging the lens before the camera to a different focal length.

### EXEMPLARY EMBODIMENTS

Although specific embodiments of systems and apparatuses are discussed in the following sections, it will be understood that these embodiments are provided as exemplary and are not intended to be limiting.

### Example 1: Methods

The fabricated metasurfaces are characterized on a custom-built optical transmission microscope (FIG. 15). Coherent light from a wavelength-tunable diode laser (Santec TSL-510) is loosely focused on the metasurface. The transmitted light is collected with an objective lens (20×, 0.4 NA, Mitutoyo) and projected either onto a InGaAs IR camera (Xenics Bobcat 320) or a power meter (Thorlabs S122C). For measuring the transmission spectrum, the laser wavelength is scanned, and the transmitted power is recorded with the power meter. For the power normalization the sample is removed, and the illuminated power through the same area is recorded. For the beam deflection measurements, a Fourier plane is imaged onto the camera and a 0.9 NA objective lens is used to capture all diffraction orders. For characterizing the lenses, the focal plane is imaged on to the camera and a scan along the optical axis is obtained by moving the surface along the z direction.

The transmission of the metasurfaces, T=P_{T}/P_{I}, is calculated by recording the power transmitted though the metasurface, P_{T}, normalized by the power incident on the metasurface, P_{I}. For the beam deflectors, the diffraction efficiency is defined as the fraction of transmitted power coupled into a specific diffraction order. To this end the intensity around each diffraction order is integrated within a square with a side length of 4 FWHM of the intensity of the diffraction order. For the metalenses the diffraction efficiency is defined as the fraction of transmitted power coupled into a circle around the focal spot with a radius of 2 times the airy disk radius.

Scanning electron micrographs are acquired on an FEI Nova 200 NanoLab system to measure the sizes of the fabricated structures. For imaging, the surfaces are covered with a 2 nm thick gold layer by sputter deposition.

The metasurfaces are fabricated on borosilicate glass substrates (n=1.503) with a thickness of 220 μm. To remove organic residues from the surface, the substrates are cleaned in an ultrasonic bath in acetone, isopropyl alcohol, and deionized water each for 15 min, dried using a N₂ gun and subsequently cleaned using oxygen plasma. Amorphous silicon is deposited onto the glass using plasma-enhanced chemical vapor deposition. In a subsequent step, the nanoblocks are written in a spin coated MaN-2403 resist layer by standard electron beam lithography. The nanoblocks are then transferred to the amorphous silicon using an SiO₂ hard mask with chlorine-based inductively coupled reactive ion etching. As a last step, the residual mask is removed by immersing the samples in buffered hydrofluoric acid (1:7) for 5 s, and subsequent rinsing in deionized water. The uniform and beam deflector metasurfaces are fabricated on an area of 150 μm×150 μm. The metalenses are fabricated with a diameter of 100 um and a parabolic phase profile according to the equation

$$φ ( x , y ) = \frac{2 π}{λ} ( \sqrt{{x}^{2} + {y}^{2} + {f}^{2}} - f ) ,$$

where λ is the design wavelength and f the focal length. All metalenses are designed for a wavelength of λ about 1280 nm. The variation of the nanorod side length is set according to FIG. 2C with a discretization of 0.1 nm.

The numerical modelling of the nanostructures is carried out using an FDTD method. Simulations are performed with a commercially available FDTD software. A constant refractive index of n=1.503 is used for the borosilicate glass and a constant value of n=3.45 for amorphous silicon, as experimentally determined by ellipsometry. The simulations are carried out with a spatially coherent plane wave illumination and periodic boundary conditions are applied on all sides of the computational domain unless otherwise noted. A smallest mesh-refinement of 5 nm is used. For the oblique illumination simulations, the broadband fixed angle technique (BFAST) is used.

### Example 2: Mode Profiles and Multipole Expansion

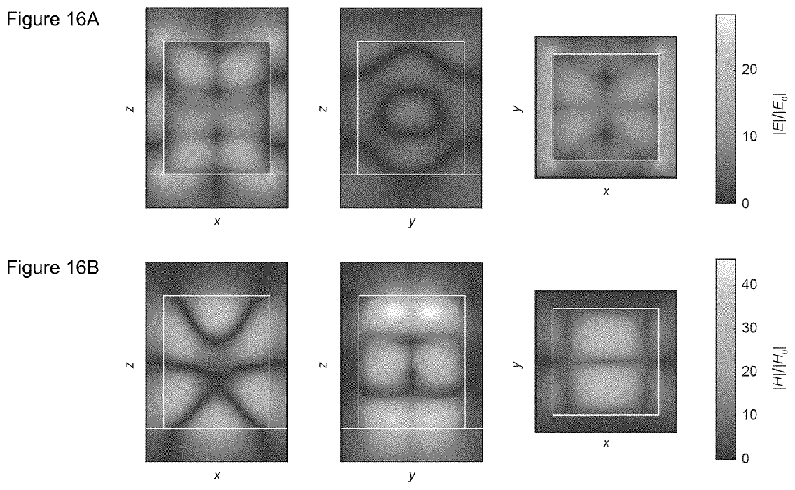

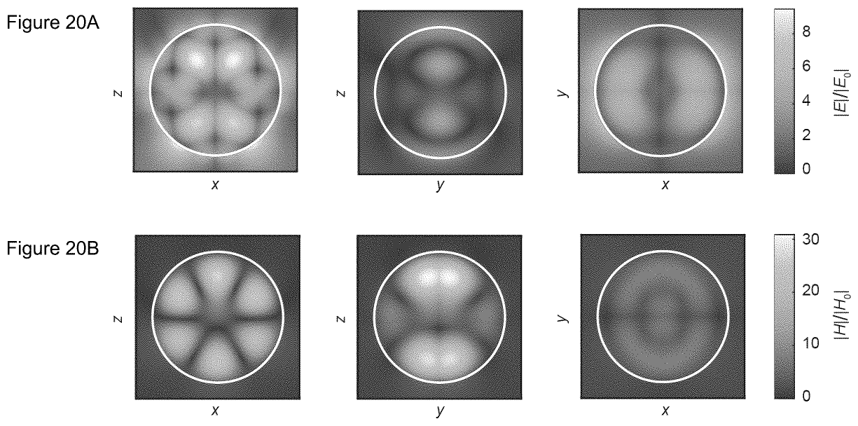

To gain an understanding of the optical modes supported by the metasurface unit cells, finite difference time domain simulations can be performed. FIGS. 16A and 16B illustrate profiles of electric and magnetic field amplitude in a periodic array in accordance with an embodiment. Simulated electric (a) and magnetic (b) field amplitude in an amorphous silicon nanoblock in a periodic array on a glass substrate with L=555 nm, H=695 nm, and P=736 nm at a wavelength λ=1288 nm. The illumination is incident along the positive z direction with the polarization along the x direction. Cross sections are shown for y=0, x=0 and z=H/2. The electric and magnetic field are normalized by the incident field amplitude E₀ and H₀, respectively. The magnetic field profile closely resembles the profile of an electric octupole mode in an isolated sphere as shown in FIG. 20. FIGS. 16A and 16B show the electric and magnetic field profiles on resonance in a periodic array of amorphous silicon nanoblocks with the size corresponding to the simulation shown in FIG. 2B. The electric and magnetic field are enhanced by a factor of 28 and 46, respectively.

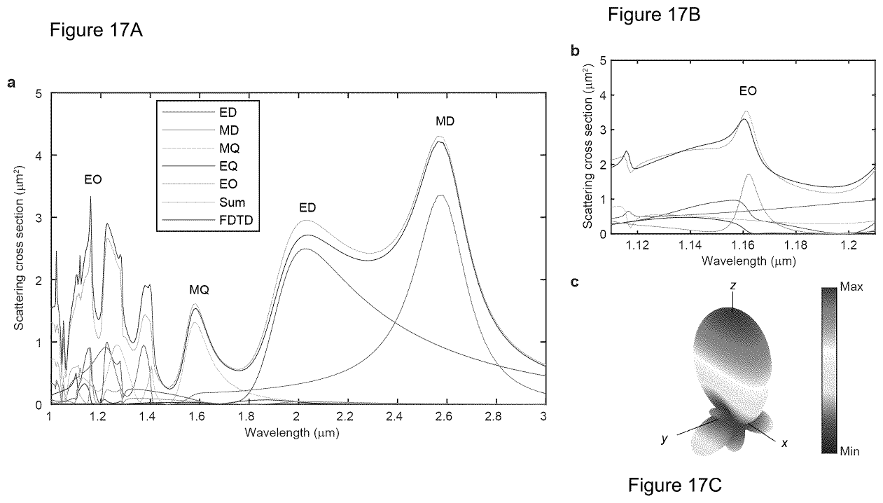

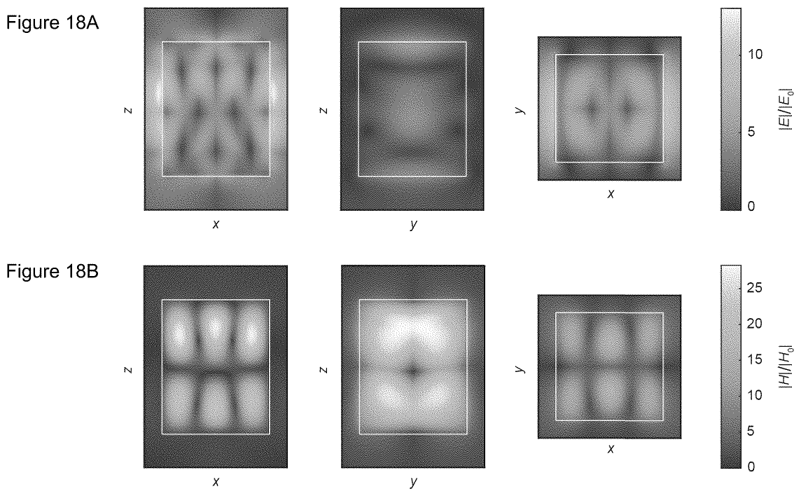

To understand the origin of the resonance mode and the high quality factor, a multipole expansion can be performed. FIGS. 17A through 17C illustrate multipole expansion of an isolated nanoblock in accordance with an embodiment. FIG. 17A shows scattering cross section of a single amorphous silicon nanoblock in free space with L=555 nm and H=695 nm calculated using the multipole expansion method. For comparison, the sum of the multipoles and the scattering cross section as calculated by FDTD is shown. FIG. 17B shows a zoomed in view of (a) over the wavelength range of the electric octupole mode. FIG. 17C shows radiation pattern of an isolated nanoblock in free space at the EO resonant wavelength λ=1.16 μm. FIGS. 17A through 17C illustrate the different resonant components of the scattering cross section of an individual nanoblock in free space as calculated from a multipole expansion. Clear resonant features are observed such as the magnetic dipole (MD), electric dipole (ED), magnetic quadrupole (MQ) and electric octupole (EO). There is good agreement between the scattering cross section calculated from the multipole expansion and the corresponding FDTD calculation. Of all the resonant modes the EO at λ=1.16 μm is specifically in the vicinity of the operation wavelength of the metasurface. The corresponding electric and magnetic field profiles of the EO at λ=1.16 μm of a single nanoblock in free space are shown in FIGS. 18A and 18B as simulated from FDTD simulations. FIGS. 18A and 18B illustrate profiles of electric and magnetic field amplitude of an isolated nanoblock in accordance with an embodiment. Simulated electric (a) and magnetic (b) field intensity in an amorphous silicon nanoblock in free space with L=555 nm and H=695 nm at a wavelength λ=1.16 μm. The illumination is along the positive z direction with the polarization along the x direction. Cross sections are shown for y=0, x=0 and z=H/2. For these simulations, a total-field scattered-field source and perfectly matched layer boundary conditions were used. In the magnetic field profiles the resemblance to the field profiles of the periodic array in FIGS. 16A and 16B is evident. The linewidth of the EO is approximately 9 nm, suggesting that in a periodic array the near-field coupling of the neighboring nanoblocks further narrows the resonance, something that is also observed in low-order Mie-resonant metasurfaces. The influence of the substrate and the neighboring elements in the array red shift the EO resonance to λ=1.288 μm.

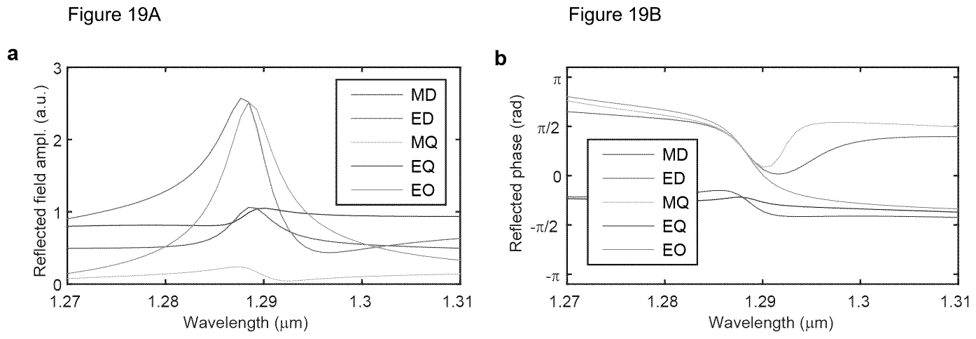

To account for the neighboring effect between different nanoblocks, some embodiments calculate the reflected field amplitude and phase of a periodic array of nanoblocks from the multipoles. FIGS. 19A and 19B illustrate multipole contributions of the periodic metasurface in accordance with an embodiment. Multipole contributions of the reflected far field electric field amplitude (a) and the corresponding phase of each component (b) for a periodic amorphous silicon nanoblock array on a glass substrate with L=555 nm, H=695 nm, and P=736 nm. FIG. 19A shows the contributions of the different multipoles towards the reflected field amplitude. A strong reflectance peak is observed at the resonance wavelength of our metasurface. The main contributions to the reflected field amplitude are due to the spectrally overlapped electric dipole and electric octupole modes. This spectral overlapping of the ED and EO, and their interference with the transmitted light, results in a narrow high quality factor resonance with a vanishing transmission on resonance. The phase of each of the multipole terms in the reflected field is shown in FIG. 19B. On resonance the ED and EO are in phase and of equal magnitude leading to a generalized Kerker effect. The presence of the EO/ED mode without a substrate and similar behavior in the reflection amplitude and phase can be obtained as for the case with a substrate shown here.

For comparison with the field profiles of the nanoblocks, FIGS. 20A and 20B illustrate the electric and magnetic field profiles of an EO mode in a spherical nanoparticle in air as calculated from FDTD simulations. FIGS. 20A and 20B illustrate profiles of electric and magnetic field amplitude of an isolated nanosphere in accordance with an embodiment. Simulated electric (a) and magnetic (b) field intensity in a nanosphere in free space with radius 400 nm and refractive index n=4 at a wavelength λ=1475 μm. The illumination is along the positive z direction with the polarization along the x direction. Cross sections are shown for y=0, x=0 and z=0. Here, the radius of the particle is 400 nm, and the index of refraction is set to n=4. In this geometry, the EO is induced at a wavelength λ=1475 nm. Notably, the magnetic field of the EO closely resembles the magnetic field in the metasurface for the periodic array of nanoblocks on a glass substrate shown in FIGS. 16A and 16B.

### Example 3: Distinction from Supercavity Modes

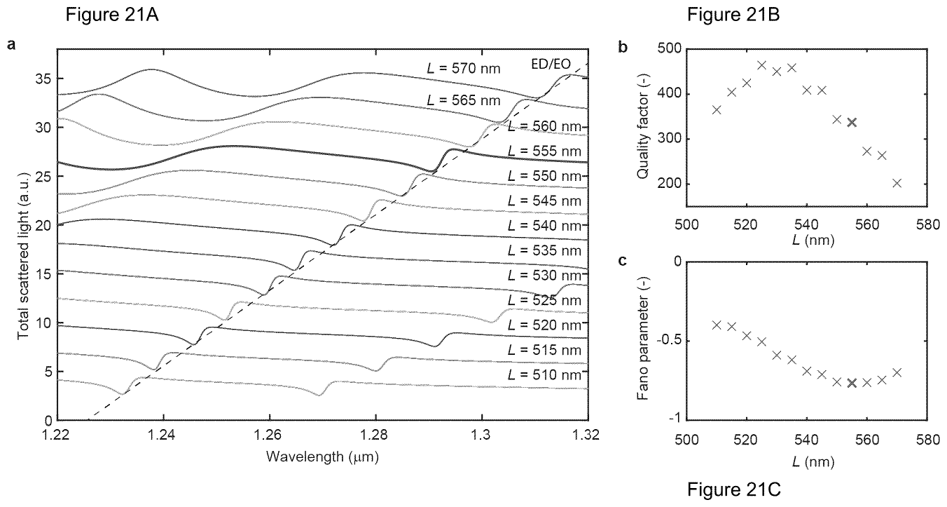

Several embodiments analyze the properties of the ED/EO mode and the light scattering of the structures in the context of local supercavity modes reported in isolated nanoparticles nanoparticles. Some embodiments record the total light scattered by a metasurface with uniformly sized nanoblocks using finite difference time domain simulations. Some embodiments employ a total field scattered field light source with periodic boundary conditions. FIGS. 21A through 21C illustrate light scattering from ED/EO metasurfaces in accordance with an embodiment. FIG. 21A shows simulated total scattered light from the higher order Mie resonant metasurfaces with H=695 nm and P=736 nm and L=510-570 nm. Curves are displaced vertically by 2.5 for better visibility. Quality factors (b) and Fano parameters (c) extracted from the total scattered light in (a) with a Fano fit. FIG. 21A illustrates the total scattered light for varying side length L of the nanoblocks and a fixed nanoblock height. FIGS. 21B and 21C illustrate the quality factor and the Fano parameter for varying L as determined from a Fano fit to the total scattered light. The data for the structure illustrated in FIG. 2B, L=555 nm, is highlighted in bold. A linear shift of the ED/EO resonance wavelength with a change nanoblock aspect ratio is observed. As compared to local supercavity modes, the ED/EO mode does not undergo a mode splitting and anti-crossing. Furthermore, a slow variation of the quality factor with variation of the nanoblock side length and a Fano parameter within the range of −0.8 to -0.4 are observed. Conversely, for a supercavity mode the quality factor of the scattered light varies rapidly as a function of a geometric parameter and the Fano parameter diverges to infinity at the supercavity condition. Supercavity modes may observe scattering from an isolated nanoparticle, whereas the nanoblocks in the metasurface structure in accordance with various embodiments are arranged in a sub-diffractive array, where there is significant coupling between neighboring elements. This suggests that a higher order Mie resonant metasurface is different from the localized supercavity modes.

### Example 4: Mode Localization

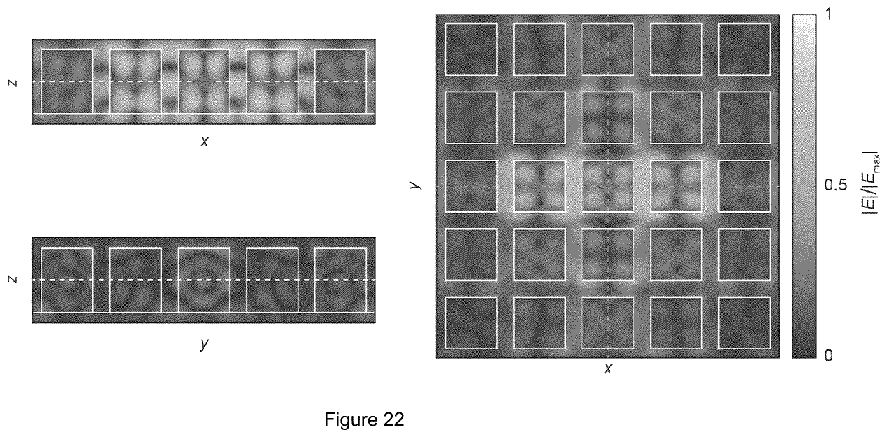

To investigate the localization of the ED/EO mode, several embodiments perform FDTD simulations where the mode is excited in a single resonator within a finite sized array (11×11 repetitions). The mode is resonantly excited with an electric dipole source at the center of the resonator polarized along the x direction. The electric field components around the excited resonator over an area of 5×5 repetitions are recorded. The electric field is recorded using an apodization time to suppress the initial field components of the dipole excitation. FIG. 22 illustrates dipole excitation of EO/ED mode in accordance with an embodiment. Electric field amplitude profiles in an x-z cross section for y=0 nm, in a y-z cross section for x=0 nm and in a x-y cross section for z=H/2 as indicated by the white dashed lines. The field intensity color scale for all the panels is identical. The red arrow indicates the position of the electric dipole that was used to excite the mode. The geometrical parameters of the structure are L=555 nm, H=695 nm, and P=736 nm. FIG. 22 illustrates the electric field intensity in different cross sections around the excited central resonator. The electric field pattern in the central resonator is identical to the one of the resonators in the periodic array (FIGS. 16A and 16B). As a measure of mode localization, the ED/EO mode volume according to

$$V = \int \frac{ε ( r ) \cdot {\vert E ( r ) \vert}^{2}}{max ( {\vert E ( r ) \vert}^{2} )} {dr}^{3} , \qquad ( 1 )$$

where E denotes the electric field at position r. In the calculation, a mode volume is of 1.8 μm³. The volume of a unit cell is estimated to 0.736 μm×0.736□μm×0.895 μm≈0.5 μm³, with an added 0.2 μm to the height as an approximate extent of the evanescent component in z. Comparing this volume to the mode volume, suggests that the mode is localized around a single resonator and its nearest neighbors. This can also be observed in FIG. 22.

In a separate analysis, the reflection of a finite-sized array of uniformly sized nanoblocks is studied. The reflection of a uniform N×N array of nanoblocks is as a summation of the backward scattering σ_{u,L} of each nanoblock with length L

$${R}_{u , L} = γ {\sum }_{n}^{{N}^{2}} {σ}_{u , L} = γ \cdot {N}^{2} \cdot {σ}_{u , L} , \qquad ( 2 )$$

where γ is a lumped parameter accounting for the finite size and light coupling to each nanoblock. Next, a perturbation is added in the array, by modifying the length of one nanoblock in the array to L+dL. Assuming the hypothesis that the scattering of each nanoblock is independent. For this case, the total reflection of the perturbed array can be obtained by

$${R}_{p , L + dL} = γ {\sum }_{n}^{{N}^{2} - 1} {σ}_{u , L} + γ \cdot {σ}_{p , L + dL} = γ \cdot ( {N}^{2} - 1 ) \cdot {σ}_{u , L} + γ \cdot {σ}_{p , L + dL} , \qquad ( 3 )$$

where σ_{p,L+dL} represents the backward scattering of a single nanoblock with length L+dL in a perturbed array. Following this logic, by combining Eq. (2) and (3), the difference in backward scattering between an individual nanoblock of length L and one of length L+dL can be retrieved as

$$Δ {σ}_{pu} = {σ}_{p , L + dL} - {σ}_{u , L} = \frac{{R}_{p , L + dL} - {R}_{u , L}}{γ} . \qquad ( 4 )$$

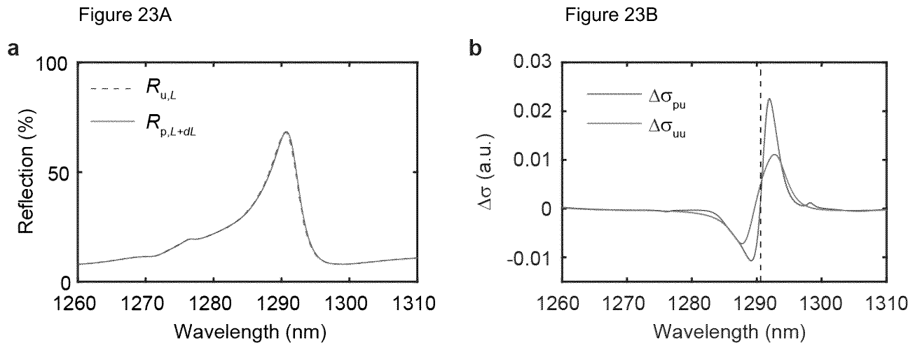

This difference can then be determined from FDTD simulations. Two simulations are preformed, one simulation with an identical array of nanoblocks with L=555 nm, and another simulation of a perturbed array, where the central nanoblock has a length of L+dL=558 nm and the remaining nanoblocks L=555 nm. FIGS. 23A and 23B illustrate reflection and scattering analysis in accordance with an embodiment. FIG. 23A shows simulated reflection spectrum of a finite sized array (9×9) of amorphous silicon nanoblocks on a glass substrate of a uniform array with L=555 nm, and a perturbed array with the central resonator of length L+dL=558 nm and the remaining resonators with length L=555 nm. In both cases, H=695 nm, and P=736 nm. FIG. 23B shows difference in the backward scattering as calculated by Eq. (4) or (5). The dashed line highlights the resonance wavelength of the uniform array with L=555 nm. FIG. 23A illustrates the recorded reflection for both cases. There is a very small difference between the overall reflection of the uniform and the perturbed array. This shows that the resonance and the quality factor of the mode are robust with respect to the perturbation. With the use of Eq. (4), the difference in backward scattering can be calculated as shown in FIG. 23B. To validate our hypothesis of independent nanoblocks the same difference in backward scattering is calculated from the reflection of two uniform, unperturbed arrays by using Eq. (2),

$$Δ {σ}_{uu} = {σ}_{u , L + dL} - {σ}_{u , L} = \frac{{R}_{u , L + dL} - {R}_{u , L}}{{N}^{2} γ} . \qquad ( 5 )$$

FIG. 23B shows the calculated difference in backward scattering Δσᵤᵤ and Δσₚᵤ. A positive value of Δσₚᵤ at wavelength larger than the resonance wavelength corresponds to a redshift of the scattering of the nanorod with length L+dL, as expected from the uniform array calculation. The differences in scattering, Δσᵤᵤ and Δσₚᵤ, show good qualitative agreement. This indicates that, to a first approximation, the scatterers can be treated of as independent from each other, hence allowing for a local control of the scattering properties of each nanoblock. As such, the nanoblocks can be approximated as effective local point scatterers. The difference in scaling between Δσᵤᵤ and Δσᵤₚ is likely due to finite size effects related to the scattering in the perturbed array and nearest neighbor interaction.

### Example 5: On the Non-locality of Asymmetry Induced q-BIC Modes

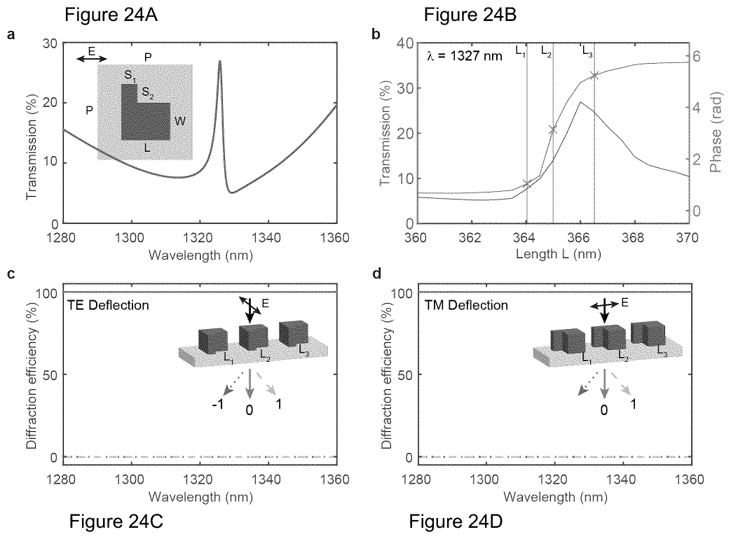

Some embodiments investigate mode localization and resonance-based beam steering. The high-quality factor resonance observed in a q-BIC structure can also be used for modulating the phase of the transmitted light. To illustrate this, we simulate the structure in Campione et al. with geometric parameters adapted to shift the resonance to the near infrared spectral range. (See, e.g., Campione, S .; et al., ACS Photonics 2016, 3 (12), 2362-2367; the disclosure of which is incorporated by reference.) FIGS. 24A through 24D illustrate non-locality of asymmetry induced q-BIC prohibits 2D resonance-based wavefront manipulation in accordance with an embodiment. FIG. 24A shows simulated transmission of a periodic array of asymmetry induced q-BIC structure based on the work of Campione et al. The resonator consists of amorphous silicon and the geometric parameters are scaled to the near infrared range and correspond to L=365 nm, W=280 nm, S₁=120 nm, S₂=140 nm, P=716 nm and a height of 326 nm. FIG. 24B shows simulated transmission and phase of the transmitted light with varying length L, showing the resonance based tuning of the array transmission. The rod lengths L₁, L₂ and Ls correspond to the rod lengths of a beam deflection metasurface with three nanorods per Fresnel zone. FIG. 24C shows simulated diffraction efficiency of a TE beam deflection metasurface using the nanoblocks with L₁, L₂ and L₃, designed to deflect light to 38.2° at an operating wavelength of 1327 nm. FIG. 24D shows simulated diffraction efficiency for a TM beam deflection metasurface using the nanoblocks with L₁, L₂ and L₃, designed to deflect light to 38.2° at an operating wavelength of 1327 nm. Due to the non-locality of the q-BIC mode, in both designs all transmitted light resides in the normal direction, illustrating the inability to perform beam steering with these structures. A narrow resonance is obtained in transmission with Q=651 as illustrated in FIG. 24A. Similar to the higher-order Mie-resonant metasurface presented here, modifying the length L of the q-BIC resonator, can be used to spectrally shift the resonance and imprint a phase shift covering close to the entire phase range of 0-2π (FIG. 24B). Based on the relationship between phase and length L, a hypothetical beam deflection metasurface can be designed. Here, a metasurface with three notched nanoblocks are used per Fresnel zone, with lengths L₁, L₂, and L₃, designed to deflect light to 38.2° at a wavelength of 1327 nm. As shown in FIGS. 24C and 24D, for both TE and TM Deflection, 100% of the transmitted light remains in the normal direction, and no light is coupled to the angles ±38.2°. This is due to the non-locality of asymmetry-induced q-BIC modes, which inherently prohibits beam steering. This represents a substantial difference to the higher-order Mie-resonant metasurfaces demonstrated here, where the locality of the mode enables wavefront manipulation in two dimensions. While conventional design approaches fail to achieve wavefront manipulation, notably, topological optimization can be employed to realize high-Q metagratings for 1D beam deflection with symmetry protected q-BIC structures.

### Example 6: Effect of Geometric Parameter Variation

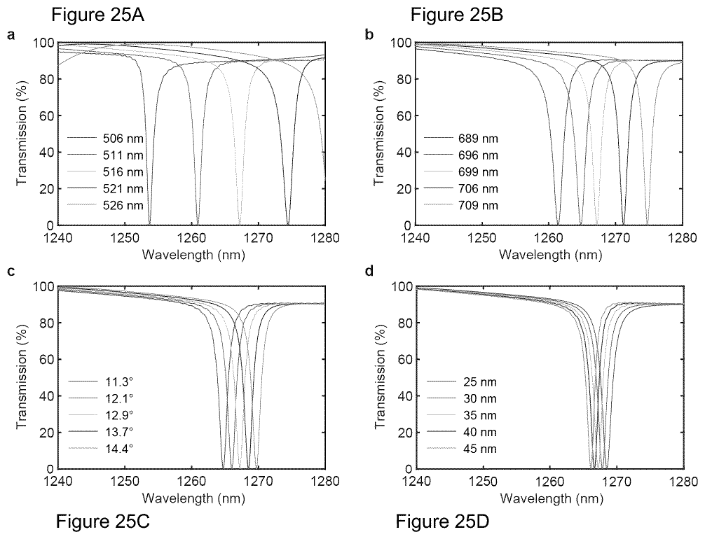

The variation of geometric parameters has a large effect on the optical properties of high quality factor metasurfaces. To analyze this effect, a uniform nanoblock array with the geometrical parameters from FIGS. 5A and 5B is simulated and examine the effect of changing the nanoblock side length L, height H, side wall tilt angle α and undercut depth dᵤ. FIGS. 25A through 25D illustrates effect of geometric parameter variation in accordance with an embodiment. FIG. 25A shows simulated transmission of a nanoblock array with dimensions, P=736 nm, H=699 nm, α=12.9°, a dᵤ=35 nm deep and 65 nm wide undercut, and varying rod length L. FIG. 25B shows simulated transmission of the structure in (a) with L=516 nm and varying nanoblock height. FIG. 25C shows simulated transmission of the structure in (a) with L=516 nm and varying nanoblock side wall angle α. FIG. 25D shows simulated transmission of the structure in (a) with L=516 nm and varying undercut of the nanoblock. The figures show the simulated transmission for the variation of these geometrical parameters. Notably, the variation of each parameter manifests itself mainly in a spectral shift of the optical resonance. For the variation of the nanoblock side length (FIG. 25A) this shift is most pronounced, with 1.3 nm wavelength per nanometer side length change.

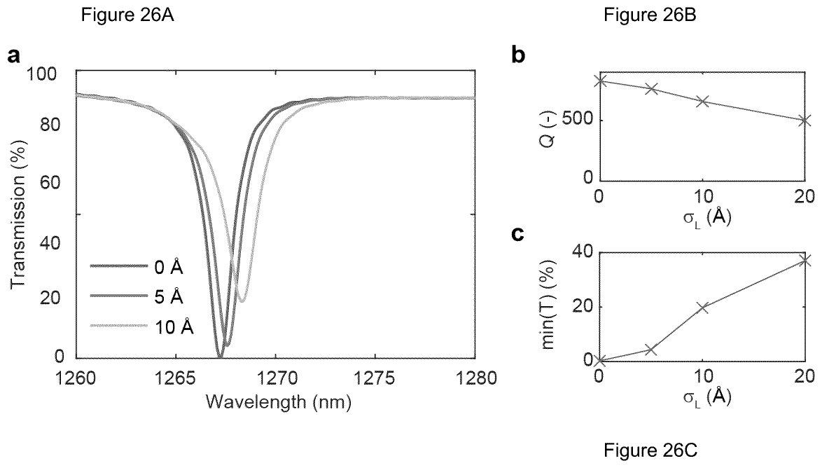

In experiment, a non-uniformity of the geometric parameters over the metasurface aperture results in a superposition of many of high-Q scatterers with varying resonant wavelength. Consequently, a variation of L, H, α or dᵤ, is expected to result in a wider resonance peak of the surface, hence a reduced quality factor and an increase in the transmission minimum of the surface. To further understand this effect, some embodiments numerically model the non-uniformity of the structure by limiting the variation only to the nanoblock side length, since the side length has the largest effect on the spectral resonance shift. Some embodiments model the non-uniformity by considering a 4×4 array of nanoblocks that is periodically repeated and impose a normal distribution of the side length on the 16 nanoblocks in the array. FIGS. 26A through 26C illustrate the effect of nanoblock side length variation in accordance with an embodiment. FIG. 26A shows simulated transmission of a nanoblock array with randomly varying side length L according to a Gaussian distribution with mean L=516 nm and varying standard deviation σ_{L}=0, 5, 10 Å. The geometry of the structure is in accordance with the geometry in FIGS. 5A and 5B, namely a sidewall tilt α=12.9° , height H=699 nm, a length and height SiO₂ hard mask of L_{SiO2}=416 nm and H_{SiO2}=120 nm, and a dᵤ=35 nm deep and 65 nm wide undercut. FIG. 26B shows simulated quality factor of the nanoblock array in (a) with varying standard deviation of the Gaussian distribution. FIG. 26C shows simulated minimum transmission on resonance of the nanoblock array in (a) with varying standard deviation of the Gaussian distribution. The structure dimensions for the simulation are the same as for FIGS. 5A and 5B. The FDTD simulation here considers a periodic array (i.e. a periodic repetition) of 4×4 nanoblocks, each with a different side length according to a Gaussian distribution.

FIGS. 26A through 26C illustrate the calculated transmission for a mean side length of L=516 nm and varying standard deviation of the normal distribution of 0, 5, 10 and 20 Å. As expected, increasing the structure non-uniformity decreases the quality factor and increases the minimum transmission. Comparing this analysis to the results of FIGS. 4A through 4C, suggests that a standard deviation of 6 Å most closely matches the experimentally observed transmission minimum and quality factor. However, in practice, all parameters L, H, α or dᵤ should obey a normal distribution with different respective standard deviations. Assuming these parameters affect the optical response independently, a compound standard deviation of the geometry can be approximated as

σₜₒₜ²=σ_{L}²+σ_{H}²+σ_{α}²+σ_{du}². (6)

The simulated case in FIGS. 26A through 26C, assumes that only σ_{L} is non-zero. For σ_{L}=6 A, any non-uniformity in H, α or dᵤ will result in a further decrease of the quality factor and an increase of the transmission minimum. This value therefore represents an estimated upper bound, suggesting that the non-uniformity of the side length in our fabricated devices is lower than 6 A.

### Example 7: Reflective Higher-Order Mie-Resonant Metasurfaces

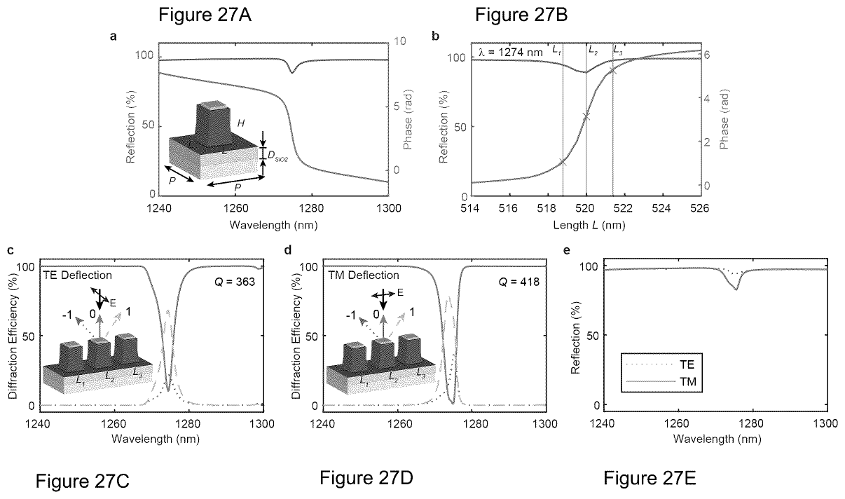

To avoid a strong variation of the scattered electric field amplitude from the metasurface unit cell, a gold reflector can be added to the metasurface with an SiO₂ gap between the nanoblocks and the reflector. FIGS. 27A through 27E illustrate reflective higher-order Mie-resonant metasurfaces in accordance with an embodiment. FIG. 27A shows simulated reflectance of a periodic array of nanoblocks on a gold reflector with dimensions to L=520 nm, H=699 nm, P=736 nm, d_{SiO2}=500 nm, sidewall tilt α=12.9°, height H=699 nm, L_{SiO2}=416 nm and H_{SiO2}=120 nm, and dᵤ=35 nm. FIG. 27B shows simulated reflectance and phase of the reflected light with varying length L, showing the resonance based tuning of the phase of the reflected light. The rod lengths L₁, L₂ and L₃ correspond to the rod lengths of a beam deflection metasurface with three nanoblocks per Fresnel zone. The reflectance remains above 88%, across the resonance. Similar to FIG. 2C, the nanoblock side length can be adjusted to set the phase of the reflected light. Using this relation of phase vs. side length, beam deflectors analogous to the ones in FIG. 6 can be designed. FIG. 27C shows simulated diffraction efficiency of a TE beam deflection metasurface using the nanoblocks with L₁, L₂ and L₃, designed to deflect light to 35.2° at an operating wavelength of 1274 nm. FIG. 27D shows simulated diffraction efficiency for a TM beam deflection metasurface using the nanoblocks with L₁, L₂ and L₃, designed to deflect light to 35.2° at an operating wavelength of 1274 nm. FIG. 27E shows simulated reflection for the TE and TM beam deflection metasurface. A peak diffraction efficiency of 68% for the TE and 79% for the TM case is attained. At the operation wavelength 1274 nm a total efficiency of light deflection of 65% and 69% is observed for TE and TM deflection, respectively.

### Example 8: Performance Metrics

The metasurfaces shaping wavefront in two dimensions with high quality factor in accordance with many embodiments are based on geometric phase and the rotation of high quality factor birefringent unit cells, also known as non-local metasurfaces. The response of these non-local metasurfaces can be described by a bandstructure, with their resonance frequency for an incidence angle θ given by

ωᵣₑₛ=ω₀+bk², (7)

where b is the band curvature, k=k₀ sin θ, k₀ the free space wave vector, and ω₀ is the resonant angular frequency of at k=0.

Quality factor: In non-local metasurfaces with uniform phase (i.e. no wavefront manipulation) the quality factor can be tuned to very large number following the relation Q˜1/δ, where δ represents a geometrical perturbation of the unicell. However, when imprinting a phase profile on the metasurface the quality factor is largely reduced due to the bandstructure dispersion. For this reason, the quality factors that have been demonstrated for wavefront manipulation are limited, i.e. for 1D beam deflection/focusing up to Q≤300, and for 2D wavefront manipulation Q≤86 for a radial lens. The higher-order Mie-resonant metasurfaces in accordance with some embodiments have quality factor of less than or equal to about 880 for 2D manipulation, and quality factor of less than or equal to about 1492 for 1D manipulation. In higher-order Mie-resonant metasurfaces, the quality factor is limited by the specific Mie-modes employed. The ED/EO shows Q less than or equal to about 668. With other higher-order modes an increased Q can be attained. Furthermore, the high Q-factor is also preserved for wavefront manipulation. Higher wavefront-shaping quality factors can be attained for beam deflection or focusing, as these depended on the specific alignment of the phase different resonators.

Numerical aperture: In non-local metasurfaces, the maximum attainable numerical aperture of an optical element is limited by the dispersion of the resonance wavelength by

$${NA}^{2} < \frac{{ω}_{0}}{{k}_{0}^{2} \vert b \vert Q} . \qquad ( 8 )$$

This can limit the numerical aperture to less than 0.26 with a quality factor of 86. For higher quality factors the attainable numerical aperture further decreases. Higher-order Mie-resonant metasurfaces in accordance with embodiments do not show a limit on numerical aperture for wavefront shaping, enabling the present demonstration of high-Q metalenses with numerical apertures of greater than or equal to about 0.8.

Limitation of efficiency: The overall efficiency of wavefront shaping with non-local metasurfaces is limited to less than 25% due to their use of geometric phase and the resulting polarization conversion. Higher efficiencies can be attained with multilayer metasurfaces, but these are difficult to realize experimentally at optical wavelengths, due to demanding overlay fabrication accuracies. In higher-order Mie-resonant metasurfaces in accordance with some embodiments, there is no limit on the overall efficiency, and high efficiencies can be attained with simple single layer designs.

Incident angle dependence/dispersion: The bandstructure of non-local metasurfaces shows a dispersion that depends on the orientation of the incidence angle with respect to the perturbation in the structure. Along the direction of the perturbation (TM) the dispersion amounts to a resonance wavelength shift of about 70 nm/10° change in incidence angle. Along the orthogonal direction (TE), the dispersion amounts to a resonance wavelength shift of 9 nm/10° change in incidence angle. Higher-order Mie-resonant metasurfaces in accordance with embodiments show a dispersion with resonance wavelength shift of less than 2 nm /10° change in incidence angle in both directions. This shows that higher-order Mie-resonant metasurfaces are much less sensitive to illumination conditions and can operate with focused/diverging and oblique illumination.

Polarization dependence: Non-local metasurfaces require illumination with circularly polarized light of the correct handedness. This requires additional polarization optics for interfacing these surfaces with a light source. Furthermore, to reject unconverted light, a second polarizer is required in the detection. Higher-order Mie-resonant metasurfaces in accordance with embodiments show a polarization-independent response and hence do not require additional polarization optics for integration.

Fabrication requirements: The fabrication requirements of high quality factor optical elements are generally demanding. Small changes in geometrical parameters of the unit cell can spectrally shift the optical resonance and hence affect the optical device performance, by resulting in errors in the scattered electric field amplitude and/or phase. In non-local metasurfaces this resonance shift can be 1.6 nm wavelength per nanometer change in unit cell dimensions. In higher-order Mie resonant metasurfaces in accordance with embodiments this shift is about 1.3 nm wavelength per nanometer change of the unit cell dimensions (FIGS. 25A through 25D). To attain efficient wavefront shaping with high quality factors (>600), both approaches require sub-nanometer accuracy of the fabricated structures. For higher-order Mie-resonant metasurfaces, these fabrication requirements can be met with standard clean room fabrication techniques.

Potential for active spatial light modulation: Non-local metasurfaces employ Pancharatnam-Berry phase (also known as geometric phase) for wavefront manipulation, whereas higher-order Mie-resonant metasurfaces in accordance with embodiments use resonance phase. For metasurfaces relying on geometric phase, the phase profile is permanently imprinted on the surface based on the fabricated geometry and cannot be arbitrarily reconfigured with an external input (e.g. by applying electrical voltage). While simple reconfiguration such as on-off switching or deformation of the phase profile has been demonstrated with non-local metasurfaces, an arbitrary reconfiguration of the phase is difficult for non-local metasurfaces, since it would require the in-plane re-orientation of the fabricated unit cells. Resonance-phase based metasurfaces may allow for such an arbitrary reconfiguration of the phase profile (e.g. continuous beam steering) at up to microsecond time scales. For higher-order Mie-resonant metasurfaces in accordance with embodiments such a realization is straightforward, for example by using the materials with a thermo-optic, or electro-optic effect to spectrally shift the resonance and perform active phase modulation.

### Example 9: Design Parameters

Table 1 lists design parameters of beam deflector metasurfaces. Parameters are given for all the beam deflector metasurfaces in FIGS. 6A through 6F. The fabricated metasurface size is about 150 μm×150 μm. The periodicity of the nanoblocks P is about 736 nm.

| | | | Phase gradient | Fresnel Zones | Nanoblocks per | Designed nanoblock |
|---|---|---|---|---|---|---|
| FIG. panel | λ_{R} (nm) | θ (°) | (rad/μm) | per surface | Fresnel Zone | lengths (nm) |
| 6a, b, c, d | 1295 | 26 | 2.134 | 51 | 4 | [587.1, 588.6, 588.8, 591.5] |
| 6c, d | 1272.5 | 25.6 | 2.134 | 51 | 4 | [569.1, 570.6, 570.8, 573.5] |
| 6c, d, e, f | 1280.8 | 25.8 | 2.134 | 51 | 4 | [575.1, 576.6, 576.8, 579.5] |
| 6c, d | 1306.3 | 26.3 | 2.134 | 51 | 4 | [603.1, 604.6, 604.8, 607.5] |
| 6c, d | 1319.4 | 26.6 | 2.134 | 51 | 4 | [613.1, 614.6, 614.8, 617.5] |
| 6e, f | 1277.7 | 16.8 | 1.423 | 34 | 6 | [574.2, 576.2, 576.4, 576.6, |
| | | | | | | 577.1, 581.4] |
| 6e, f | 1281.2 | 20.4 | 1.707 | 40 | 5 | [574.6, 576.3, 576.5, 576.7, |
| | | | | | | 580.8] |
| 6e, f | 1289 | 35.7 | 2.846 | 68 | 3 | [575.6, 576.6, 578.7] |

Table 2 lists design parameters of metalenses. Design parameters are given for the metalenses in FIGS. 10A through 10J and FIGS. 12A through 12E. The periodicity of the nanoblocks P is about 736 nm. The phase distribution is parabolic and the nanorod lengths are chosen according to FIG. 2C. A constant offset is equally added to all nanoblocks of a metalens, resulting in the variation of the resonance wavelengths in FIG. 10F.

| Lens | | | | Nanoblocks per |
|---|---|---|---|---|
| diameter | Focal | Numerical | Fresnel Zones | Fresnel |
| (μm) | length (μm) | aperture | per surface | Zone |
| 100 | 495 | 0.1 | 2 | 20-48 |
| 100 | 274 | 0.18 | 4 | 9-36 |
| 100 | 114.6 | 0.4 | 4 | 5-24 |
| 100 | 66.6 | 0.6 | 13 | 3-18 |
| 100 | 37.5 | 0.8 | 39 | 2-14 |

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. An apparatus comprising:
an electromagnetic metasurface comprising a plurality of repeating unit cells with a periodicity conformally disposed on a substrate; wherein the periodicity is less than a wavelength in free space of an operating light;
wherein each of the plurality of repeating unit cells comprises at least one nanostructure with a length, a width, and a height; wherein each of the length and the width is less than the periodicity; and
wherein at least two different Mie-modes, with one Mie-mode being a higher order, interfere within each of the plurality of repeating unit cells, the interference enables the apparatus to achieve a resonance in transmission or reflection such that the apparatus controls a phase of the operating light in transmission or reflection using a localized mode with a quality factor of at least 200.

2. The apparatus of claim 1, wherein the at least two Mie-modes are selected from the group consisting of: an electric dipole, a magnetic dipole, an electric quadrupole, a magnetic quadrupole, an electric octupole, a magnetic octupole, an electric hexadecapole, a magnetic hexadecapole, electric 32 pole, and a magnetic 32 pole.

3. The apparatus of claim 1, wherein the apparatus controls the phase of the transmitted light or reflected light in two dimensions.

4. The apparatus of claim 1, wherein the wavelength is selected from the group consisting of: an ultraviolet wavelength from 100 nm to 400 nm, a visible wavelength from 380 nm to 800 nm, a near infrared wavelength from 800 nm to 2500 nm, and an infrared wavelength from 780 nm to 1000 μm.

5. The apparatus of claim 1, wherein the plurality of repeating unit cells is arranged in an array.

6. The apparatus of claim 1, wherein the at least one nanostructure has a shape selected from the group consisting of: a cuboid, a cube, a pillar, a cylinder, an elliptical cylinder, a trapezoid, a triangular prism, a polygonal prism, a pyramid, and a combination thereof.

7. The apparatus of claim 1, wherein the at least one nanostructure has a non-symmetric shape.

8. The apparatus of claim 1, wherein the at least one nanostructure comprises a lossless dielectric material with an imaginary refractive index less than or equal to 0.5 at the wavelength of operation.

9. The apparatus of claim 1, wherein the substrate comprises a material with a real part of the refractive index less than the real part of the refractive index at the wavelength of operation of the at least one nanostructure.

10. The apparatus of claim 1, wherein the at least one nanostructure comprises a material selected from the group consisting of: gallium arsenide, gallium phosphide, silicon carbide, titanium oxide, silicon nitride, barium titanate, lithium niobate, tantalum pentoxide, silicon oxide, amorphous silicon, silicon, and a combination thereof.

11. The apparatus of claim 1, wherein the substrate comprises a material selected from the group consisting of: glass, silicon oxide, silicon nitride, gold, silver, aluminum, copper, titanium, platinum, indium tin oxide, aluminum tin oxide, aluminum zinc oxide, magnesium fluoride, tantalum pentoxide, zirconium oxide, vanadium oxide, a germanium-antimony-tellurium alloy, titanium nitride, hafnium oxide, hafnium nitride, molybdenum diselenide, hexagonal boron nitride, black phosphorous, tungsten diselenide, tungsten disulfide, and a combination thereof.

12. The apparatus of claim 1, wherein the quality factor is observed in an area with a diameter of less than or equal to 100 μm due to the localized mode.

13. The apparatus of claim 1, wherein the wavelength is a near infrared wavelength from 800 nm to 2500 nm, the at least two different Mie-modes are an electric dipole mode and an electric octupole mode, and the quality factor is from 202 to 1475.

14. The apparatus of claim 1, wherein the electromagnetic metasurface is configured to be a part of a band-stop filter, a beam deflector, a lens, a beam splitter, or a hologram.

15. The apparatus of claim 14, wherein the lens has a numerical aperture of greater than or equal to 0.8.

16. The apparatus of claim 1, wherein the apparatus is polarization independent.

17. The apparatus of claim 1, wherein the electromagnetic metasurface is configured to be a part of a sensor in a liquid environment or in a gaseous environment.

18. The apparatus of claim 1, wherein a refractive index of each of the plurality of repeating unit cells is dynamically varied using a mechanism selected from the group consisting of: a thermo-optic effect, an electro-optic effect, a magneto optic effect, a nonlinear Kerr effect, and by electrical or optical injection of free charges in to a material of each of the plurality of repeating unit cells.

19. The apparatus of claim 1, wherein the substrate comprises one or more layers;
wherein a refractive index of at least one layer of the substrate is varied using a mechanism selected from the group consisting of: a thermo-optic effect, an electro-optic effect, a magneto-optic effect, a nonlinear Kerr effect, and by electrical or optical injection of free charges in to a material of each of the plurality of repeating unit cells.

20. The apparatus of claim 1, wherein the substrate is a deformable substrate, and each of the plurality of repeating unit cells is dynamically displaced from one another by stretching the deformable substrate such that the displacement changes the periodicity.

21. The apparatus of claim 1, further comprising a plurality of the electromagnetic metasurfaces, wherein the plurality of electromagnetic metasurfaces are stacked on top of each other to manipulate a monochromatic light in a consecutive manner, or manipulate broadband illuminated light at separate wavelengths.
